(19) United States
(12) Patent Application Publication
(10) Pub. No.: US 2018/0082035 A1
(43) Pub. Date: Mar. 22, 2018

(54) Patient Monitoring System Mobile Software Applicaiton

(71) Applicants: Daniel R. Collette, Albuquerque, NM (US); Mathew P. Napier, Albuquerque, NM (US)

(72) Inventors: Daniel R. Collette, Albuquerque, NM (US); Mathew P. Napier, Albuquerque, NM (US)

(21) Appl. No.: 15/267,449

(22) Filed: Sep. 16, 2016

(51) Int. Cl. G06F 19/00

(52) U.S. Cl. CPC G06F 19/3418; G06F 19/3456; G06F 19/322

(57) ABSTRACT

This patent is a follow-on to U.S. Pat. No. 8,421,636 B2 and documents the development work done between the original patent filing and the applications of the current patient monitoring system. The patient monitoring system originally developed on its own hardware, has been migrated to an application (App) developed for electronic devices. The Patient Monitoring System App is a paperless, point of service application that removes the need for caregivers to spend a large portion of their time in documenting medical records. Point of service means that the transaction is completed at the patient (due to political correctness, the patient can be called, resident, patron, family member, individual, etc.). The application is triggered by a QR code read by the device running the application. The Zigbee or thread platforms, allow for multiple caregivers and infinite patients to function seamlessly within the same application. As an IoT based application, patient information is transmitted directly to the cloud without the necessity of a computer interface where a global application stores, processes and presents the data to users according to their requirements.

### CROSS REFERENCE TO RELATED APPLICATIONS

This application claims the priority of Provisional Patent Application No. 62/219/517, filed Sep. 16, 2015, the entire contents of which are incorporated by reference herein. It also is a follow-on application to U.S. Pat. No. 8,421,636 B2, filed Apr. 30, 2004.

### BACKGROUND

Patient Monitoring systems have improved the ability of caregivers in the critical role of overseeing the care of patients by providing a reference framework of both requirements and status of patients. Patient checks, treatments and care, which has been routinely monitored by caregivers, and which has become more complex and difficult with increasing patient loads and resources, has been augmented with the introduction of computers to track, remind and record much of the required and given patient care.

Rapid advances in electronic devices and capabilities has allowed the development of numerous applications, programmed to monitor, record events and provide a framework of care that improves quality of care and reduces the possibility of error. This patent will describe the mobile application which has been developed to further improve the monitoring and care of patients by significant changes in the way tracking, recording, and verifying of care events is managed, putting at the fingertips of every caregiver the ability to initiate and complete every transaction at the patient location, saving the time of going back and forth to a central computer, the errors that are introduced by trying to remember at a later time what transpired earlier in the day, and by eliminating the time typing into the patient records with key clicks and transcription.

Even the multi-million dollar software systems of hospitals lack the integration of hardware and software to make a truly robust system. Call buttons are still standalone systems and are tied to rooms and not patients. Thus when a patient moves to anywhere but where the call button is located, such as going for an x-ray or being moved in a wheelchair to a location other than the bed where the call system is located, the ability to call for assistance or help, is no longer available. To fully integrate a call system, and make it individual is extremely useful and adds significant capability to a caregiver application. The application was designed to address the most common issues resulting in legal action against caregivers, by features specifically designed to document and record every care event in such a way as to provide hardware and data that reduces significantly the possibility of error in patient care. These features will be discussed in further detail in the summary text.

### SUMMARY

The present disclosure is to describe the complex design and operational features that make the application described in this patent, unique and novel to any other system currently available.

Most applications written for healthcare utilize standard programming techniques to capture and record data required for government reporting. There are a few applications that collect data from a generating source and process and store it. The patient monitoring system as described in this patent, introduces complexities within the system that are unique and novel, combining software, hardware and firmware into an interactive system, providing instantaneous feedback from multiple patients to multiple caregivers, allowing selective inputs from the caregivers, assigning tasks and acknowledging and assigning responsibility to a particular caregiver. In addition, the integration of hardware into the same system, provides automatic fall detection, the ability of the patient to contact the caregiver directly, reminders and tracking to completion of all care events, the ability to precisely monitor care by management and by individual caregiver on all shifts and automatic wetness sensing which removes the necessity for manual handchecking every two hours, including at night when disruption of sleep is difficult for the patients and allows for better control of skin breakdown issues. The system allows remote monitoring by doctors and nurses of all residents because of the structure of global, local and caregiver access points in a cloud based system.

The patient monitoring system (hereafter called the “application”) is developed to encompass all the features of the previously patented application by Collette/Napier U.S. Pat. No. 8,421,636 B2 issued Apr. 16, 2013, but also to take advantage of new capabilities of electronic development to add novel features that have previously not existed, such as an integrated call.

The hardware elements of the application consist of a wetness sense module and a patient module. Even in hospitals which have the financial resources to purchase multi-million dollar software programs, patient call modules, are embedded within the hospital building structure and continue to be standalone entities where a call request from a patient is transmitted to the nurses station to be responded to when a caregiver is at the desk to acknowledge it. The application described in this patent integrates patient call directly into the application running on a device carried by the caregiver and providing immediate notification of the call request sent from the patient module. The need to return to a station point to obtain or respond to call notifications is no longer necessary, saving time and diverting resources to value added functions.

For years, patients which had fallen had no means of calling for assistance. This was eventually replaced by wireless transmitters which when triggered by pushing a button transmitted a call for help. However, often the fall resulted in conditions where the patient was unable to personally call or push a button for help. In the patent U.S. Pat. No. 8,421,636 B2, of which this patent is a continuation, a claim was made for an automatic fall detection system which required no input from the patient to trigger a notification for help. This incredibly important feature continues to be a key anchor in the application, transmitting the automatic fall notification directly to the caregiver and not to a “station location” where the caregiver must go to see who is calling. This feature is now available using the same technology in standalone systems, but since they are not integrated into a patient application, they cannot provide the immediate feedback directly to the caregiver and usually require a 3^{rd} party to intervene.

Critical to patient care is skin condition, particularly in the aged where the skin has lost it's elasticity, is the absence of urine and ammonia byproducts which rapidly degrade skin cells. Key in this application is the wetness sensing capability that has been developed for over nearly 20 years, but which is now integrated into the mobile application which makes it much easier to respond quickly to wet events.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a drawing of the Patient Monitoring System Mobile Application showing the component elements and the interactions between them.

FIG. 2 is a diagram of the Zigbee Star and Tree configurations for connectivity. The Patient Monitoring System Mobile Applications uses the Tree configuration.

FIGS. 3 and 4 are block diagrams of the Zigbee network stacks which provide the underpinnings for the Patient Monitoring System Mobile Application.

FIG. 5 is a photo of the Texas Instruments CC2531 USB dongle. It was used as the basis for the repeaters and routers developed for the Patient Monitoring System Mobile Application.

FIG. 6 is a state diagram of the Coordinator, which is the hardware interface uplinking to the cloud for the Patient Monitoring System Mobile Application.

TABLES 1-4 are the Byte configurations for the Acknowledgement Messages for Standard, Update Pan, Update Network and Update both Pan and Network.

FIG. 7 is the state diagram for the Initial Router Functions of the Patient Monitoring System Mobile Application.

FIG. 8 is the conceptual state diagram of the end point operation.

FIG. 9 is the block diagram of the CC2530 Analog Comparator which is used in the wetness sensing algorithms of the Patient Monitoring System Mobile Application.

FIG. 10 is the wetness sense circuitry which sets the threshold voltages based on resistance curves of incontinence products.

TABLE 5 is the I/O table for the Wet Event Comparator.

TABLE 6 is the Wet Event Message Packet Byte Data

TABLE 7 is the CALL and SERVICE Event I/O Port definitions

TABLE 8 is the CALL Event message packet definitions

TABLE 9 gives the SERVICE event message packet definitions.

TABLE 10 gives the PORT Names, functions and initial conditions for the 3 axis Accelerometer, the key component in the automatic fall detection capability of the Patient Monitoring System Mobile Application.

TABLE 11 is the FALL event message packet.

FIG. 12 is a state disgram of the Database Structure for the Patient Monitoring System Mobile Application.

FIG. 13 is a sample of the ICON Drawings used on the Patient Monitoring System Mobile Application as screen taps to enter pre-written entries into the Patient record for Observations and Services.

Screen Capture 1 is the global screen where new nursing homes, assisted living centers and even individual users in a home or home hospice setting.

Screen Capture 2 is used to add new residents into the Patient Monitoring System Mobile Application.

Screen Capture 3 displays the residents in any given facility.

Screen Capture 4 is the entry screen for new patients. It is also the screen which generates individual patient QR's, attaches the MAC addresses for both the Wet and Call sensors (the Call sensor also has the automatic fall detection and the visit register.

Screen Capture 5 is the entry screen for patient insurance information.

Screen Capture 6 is the entry point for patient medications.

Screen Capture 7 is the Service planning screen. This is the first step in entering service items into a patient treatment plan.

Screen Capture 8 this screen is used to enter the services and observations that are available for selection for a given patient.

Screen Capture 9 shows an individual patient log. Caregivers are recorded and completion of tasks tracked.

Screen Capture 10 is a screenshot of a patient treatment plan. Meds, meals, and services are shown in this data field.

Screen Capture 11 is the notification log for patient events.

Screen Capture 12 shows the caregivers registered for any given care facility.

Screen Capture 13 is the screen used to add new caregivers into the system.

Screen Capture 14 is the physician entry screen.

Screen Capture 15 is the medication library which underlies the dropdown menus which are used when creating new patient profiles and treatment plans.

Screen Capture 16 is used to enter new medications into the medication drop down menu.

Screen Capture 17 is the observation screen. Entries are written for the text statements which the various uses want as the entries into the patient record for observations of the caregiver. Even through the statements are preset, they can be augmented at any time by taping on the notes entry and adding additional relevant information.

Screen Capture 18 is the screen where new observations are created. Observations are totally customizable for every user of the system.

Screen Capture 19 is the services screen. Entries are written for the text statements which the various uses want as the entries into the patient record for services performed. Even through the statements are preset, they can be augmented at any time by taping on the notes entry and adding additional relevant information.

Screen Capture 20 is the screen where new services are created. Services are totally customizable for every user of the system.

Screen Capture 21 is the alerts screen. Alerts are given for calls, falls, wet events, upcoming medication deliveries and patient care plan items.

Screen Capture 22 is the observation note screen. As with all the note screens, entries can be made by text, dictation (voice), transcription by voice recognition or photos, all which go directly into the patient record with a button tap.

Screen Capture 23 is the vitals entry screen. As with all the note screens, entries can be made by text, dictation (voice), transcription by voice recognition or photos, all which go directly into the patient record with a button tap.

Screen Capture 24 is a screen shot of the application showing the pop-up reminder of critical patient items, such as allergies, risks or medical conditions that need to be remembered. This reminder decreases the chance for errors in caregiver/patient interactions.

Screen Capture 25 is the profile screen for the caregivers.

Screen Capture 26 is a photo of the WET Module circuit card assembly showing key elements of accelerometer for automatic fall detection, magnetic reed switch for recording patient visits, the non-ganged pin arrays which not only connect to the incontinence products but also verify proper connection of the wet sensor

### DETAILED DESCRIPTION

The detailed description will be divided into the 3 elements of the Patient Monitoring System Application. The first will be the description of the Patient and Caregiver Monitoring Network on which the application is built. The second will be the Patient Monitoring System and the third will be the Caregiver Application.

### Patient Monitoring Wireless Network

The purpose and scope of this document is to define the Patient Monitoring wireless network. It will cover the definition of the ZigBee Network and the resulting network nodes that will be required to implement the network. This document will enable the embedded designer to generate the micro controller code for each network node defined in this document.

Global and Unit specific functional definition/requirements are listed throughout the document It is the intent to capture this in a sequential and straight forward manner but in some cases the use of a function/item may precede the detailed definition that function/item.

The flow of this document will be as follows

Introduction:

Description of how the patient monitoring network fits into the patient monitoring system.

Introduction of the ZigBee Network and the patient monitoring network nodes and network topologies that will be utilized.

Couple of global items that impact every element of the network design ∘ Micro Controller

Definition:

A specific TI micro controller will be utilized and it is defined ∘ Network Addressing Scheme:

The ZigBee Addressing will be used but the assignment of the exact addresses will need to be coordinated with the patient monitoring software to guarantee patient to hardware database coherence

Patient Monitoring Network Definition

Patient Monitoring Software USB Driver

Firmware Coordinator and Router Definition

End Point Nodes
Wetness Sensor
Call Sensor
Development Hardware Platform

Introduction

To improve the assisted living homes patient's level of care a patient monitoring network will be implemented, this will allow the monitoring of the patient's wetness state of their diaper and allow the patient to call for care when they need it.

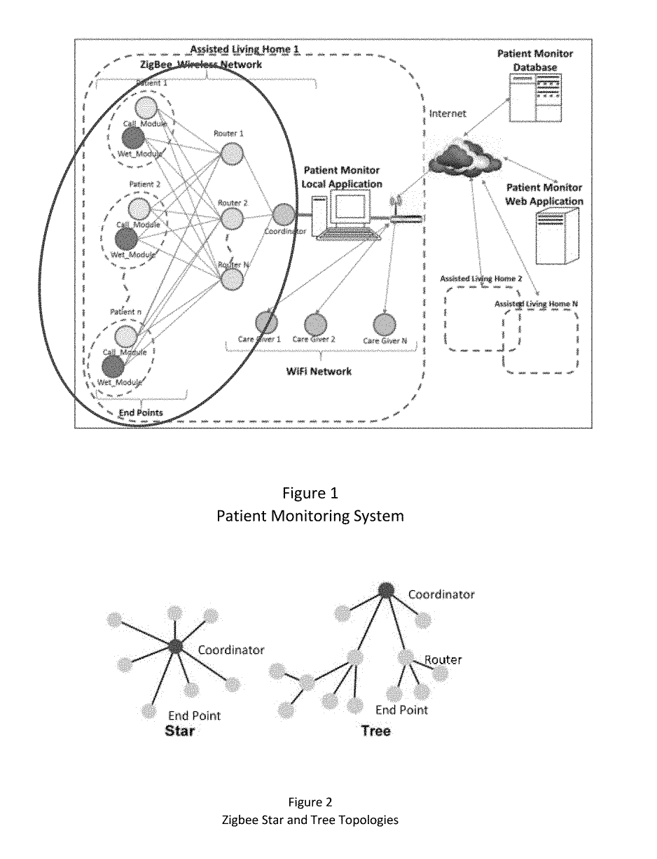

This network will integrate into the patient monitoring system and interface with the patient monitoring software. Please refer to FIG. 1, Router End Points.

Network is an industry standard, simple, reliable low power network designed for battery powered devices. The Network will consist of three node types.

The three ZigBee Node types in the patient monitoring network;
Coordinator Node: Full Function Device (FFD), “Always On”, Network controller that can communicate with all devices in the network. and interface to the Patient Monitor Software
Router Node: FFD, “Always On” Repeater Node that transmits End Point Messages to and from the Coordinator, it can communicate with all other devices but is not the main Network controller
End Point Nodes: Reduced Function Device (RFD), Low Power, “Mostly Off” Battery powered Nodes, only communicate with FFDs and cannot communicate with other RFDs
Wet Module Node: Wetness sensor attached to the patient's diaper, sends a wetness message when diaper is wet
Call Module Node: Push button call sensor that allows the patient to send a call message, service message or detect a patient fall.

The ZigBee Network will be configured into either a Star or Tree typology depending on the size of the assisted living home and transmission capabilities of the end point modules. See FIG. 2.

Star typology will be used for small homes where coordinator is within reach of all the end points. For larger homes routers will be placed throughout the home that is in reach of both the coordinator and end points creating a reliable network throughout the home. The end point nodes will move around the home during the day so the routers must have the ability to communicate with all the end point nodes.

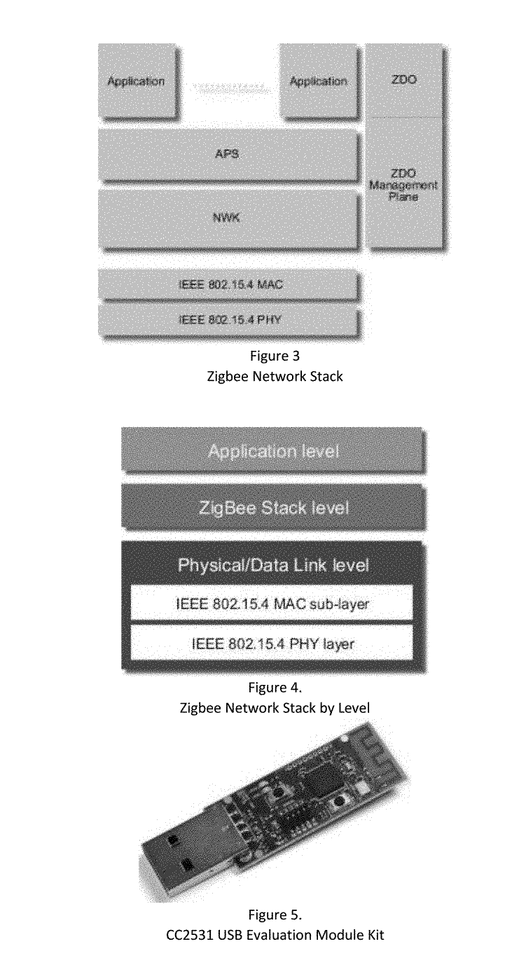

There are several communication options and configurations available at the Network, MAC and Physical layers of the ZigBee network, example, Beacon vs Non Beacon transmission modes. Beacon mode will not be used for this network because the Wet and Call end point nodes will be “mostly off” and will only “wake up” and transmit once a wet/call event has occurred, neither of these events will happen on a periodic basis. The units will wake up Sense that the environment is free of other transmissions and transmit utilizing Carrier Sense Multiple Access with Collision Avoidance (CSMA-CA); all of this is handled at the MAC or lower level and invisible to the application layer. A majority of the of these network stack configuration variables are “set and forget” and for the purpose of the patient monitoring network the default settings are sufficient but note that the primary purpose of these configurations is to create a network that will facilitate simple but robust communication and maximize the battery life of the end point nodes. For example network encryption is not required and will not be used for the patient monitoring network. See FIG. 3.

The hardware in this network will utilize the Texas Instrument CC2530 and CC2531 System on a Chip 8051 Micro Controller Unit (MCU) and 2.4 GHz IEEE 802.15.4/RF4CE/ZigBee integrated radio.

The only difference between the CC2530 and CC2531 is the CC2531 has an integrated USB controller and the CC2530 has an integrated comparator.

To support the ZigBee network stack all hardware nodes will be populated with the largest CC2530/1 available, each part will have 256 KB Flash memory. An example of the Zigbee network Stack by level is shown in FIG. 4.

In a typical ZigBee based network the Coordinator will do all the network addressing assignment/determination but since our network integrates into the patient monitoring software database the patient monitoring software will require the ability to command network addressing assignments to guarantee a “one for one” patient ID to Wet and or Call End point address mapping.

All nodes will support an initialization state where these addresses can be commanded and stored into non-volatile memory and persist through loss of power; replacement of batteries or removal of wall power.

The Network addressing scheme for this network will be:

Personal Area Network (PAN) Address: Network Address that all nodes in the network will communicate with in.

All Nodes will be coded with a default PAN of 0x0A0A

The patient software will have a USB command to command the PAN address in the coordinator and all router and end point nodes.

Via patient software commanding each new network will be assigned a unique PAN

Node Address: The ZigBee Network Address (Short Address) format will be utilized ∘ The Coordinator during initialization will assign itself a Network Address of 0x0000 Every Router and End Point Node,

Will have a default Node Address of 0x0B0B. During initialization/joining to the network it will be assigned a network address from the coordinator via the patient monitoring software.

For End Point Nodes: This allows straight forward linking of the network address to the patient being assigned to the end point node.

For Router Nodes: Will be assigned a Network ID such that they can be tied to geographic location within the house.

The Patient Monitor Software located on the local machine will interface to the patient monitor network (PMN) via a USB driver. This driver interface will support Patient Monitor Network Application Programming Interface (API). As part of the Patient Monitor Network development the definition of the API and implementation of the driver will be done.

Example lists of API capabilities are captured below:
PMN_USB_INIT( ): Function/s to initialize communication with the Coordinator node
PMN_PAN_Cor_Set( ): Function to set the coordinator PAN address
PMN_Router_INIT( ): Function/s communicating with the coordinator facilitating the addition of a new Router Node to the network, PAN and Network Address assignment
PMN_End_Point_INIT( ): Function/s communicating with the coordinator facilitating the addition of a new Wet/Call End Point Node to the network, PAN and Network Address assignment PMN_Message_Rdy( )
PMN_Message_Read( ): Function/s to read a Wet/Call event message, all event messages will also include the end point Network Address
PMN_Network_Ping( ): Function/s to allow the user to ping the network

In addition to the API a set of administrator tools will need to be developed to allow low level management of the Network. It is the expectation of the author that a set of these tools will have to be developed during the implementation effort to verify functional compliance of the network. Capabilities are (but are not limited to):

Interactive shell/GUI: Allow the user to configure and monitor all Network traffic (End Point messages), command all API commands. Support both adhoc commanding and script based commanding

Network Bubble Diagram: Simple GUI that will draw the current Network topology of the “always on” Coordinator and Routers and current knowledge of the “mostly off” Wet and Call End Point Nodes

ZigBee Network Packet Sniffer: The coordinator will receive all ZigBee packets even those outside of the PAN, integrated into the ZigBee Network packet layers is a lot of information about the health of the network. It would be nice to be able to display all ZigBee traffic real time to see how many other networks are out there and how the patient monitor network is performing. TI offers a free packet sniffer application as part of the CC2531 USB development module.

The primary function of the Coordinator and Router nodes is to create a simple and robust “always on” Network to facilitate reliable message communication of the end point nodes back to the patient monitor software system.

The coordinator node, also known as the PAN coordinator, is the main control node of the Patient Monitor ZigBee Network. It is the first node enabled in the network and will manage the network by allowing the joining of both router and endpoint nodes; it will integrate into the Patient Monitoring Software system via USB port communication. The coordinator will not need to access the end point event messages; it will pass the messages directly to the patient monitor software for processing.

The router Node will utilize the exact same hardware as the coordinator node but will only relay messages and utilize the USB port for 5V power.

Both the Coordinator and Router nodes will utilize the Texas Instrument CC2351 micro controller. The CC2351 is system on a chip with built in ZigBee stack and USB driver making it a one chip solution for both the ZigBee Network and the Patient Monitor USB interface.

The hardware platform for the coordinator and router nodes will be based off the Texas Instrument CC2531 USB Evaluation Module Kit, shown in FIG. 5.

The only difference between the evaluation module and the patient monitor coordinator and router is the PCB antenna will be replaced with a SMA dipole antenna to increase TX/RX range.

The Coordinator Node has two main functions: ZigBee Network Management and USB interface command and control to/from the patient monitor software. The Coordinator Node is always on and will maintain state between power cycles.

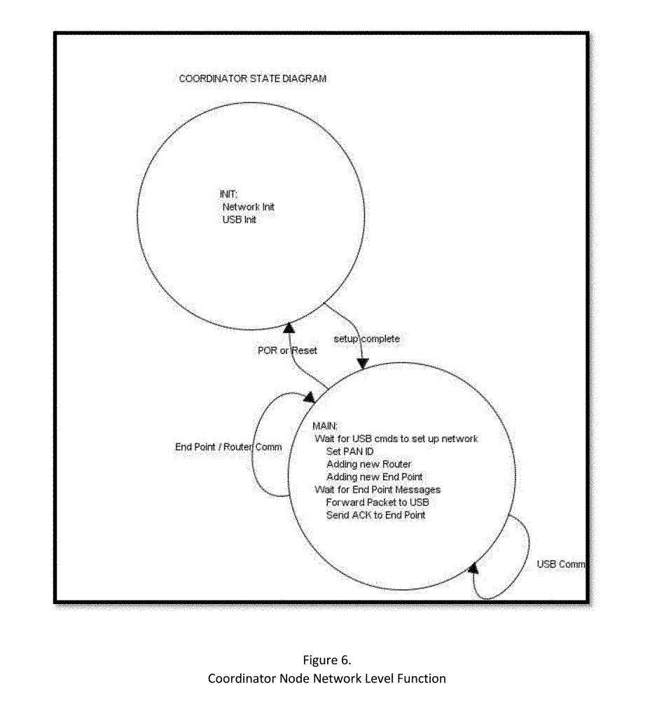

FIG. 6. is a simplified state diagram of how the coordinator node will operate.

Initial list of Coordinator Function: Initializes and Starts the network. Sets the Personal Area Network (PAN) Address via USB commanding. Sets all the init values for the PHY, MAC, NWK and ZigBee stack layers. Always on. Powered via the USB connecter. Maintains state between power cycles by writing Network Addresses to Non Volatile Memory. Always allow other devices (Routers and End Point Nodes) to connect to the Network Via patient software commanding both Routers and End Points with default PAN Addresses will be added and networks PAN address in the Router and End Point will be updated and stored in nonvolatile memory. Message routing the coordinator will be receiving 100% of all messages transmitted by the routers and end point nodes. The coordinator will send out Ack message notifying the router and/or end point that the message was received. This ack function will be managed by either the coordinator or the patient monitoring software.

Support patient monitor network API via the USB port.

Several Examples: Support PAN Address Commanding via the patient monitoring software during Setting during Coordinator End Point Message transmission to the patient monitor software via the USB interface

ACK Packet Definition: The Acknowledgement (ACK) to an endpoint event message will be used to manage the configuration of the end point.

To support dynamic commanding of the PAN and Network ID the ACK return message will be decoded by the end point to determine if either of those two fields requires an update. See Tables 1-4.

ACK messaging to manage the configuration of the end points could be expanded in the future to manage more end point configuration parameters.

During the design and development cycle more functions may be required for the Coordinator Node.

In the event an assisted living home is too large to utilize just a star based network a Tree or Mesh topology will be utilized to guarantee coverage over the entire house. Networks with Tree or Mesh topologies need at least one Router. The Router function is a subset of the Coordinator and will utilize the same hardware platform minus the USB interface. Initializes Configuration. Sets the Personal Area Network (PAN) and Network Address via Coordinator Node commanding. Sets all the init values for the PHY, MAC, NWK and ZigBee stack layers. Always on. Powered via the USB connecter. Maintains state between power cycles by writing Network Addresses to Non Volatile Memory. Always allow other devices (Routers and End Point Nodes) to connect to it. The End Point Nodes will move around the house and will not always communicate with the same router.

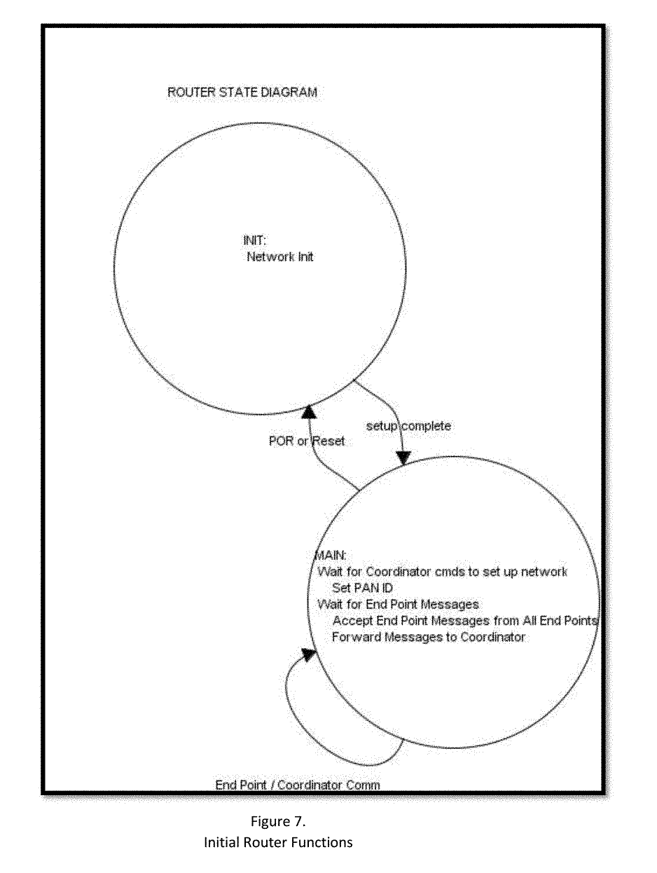

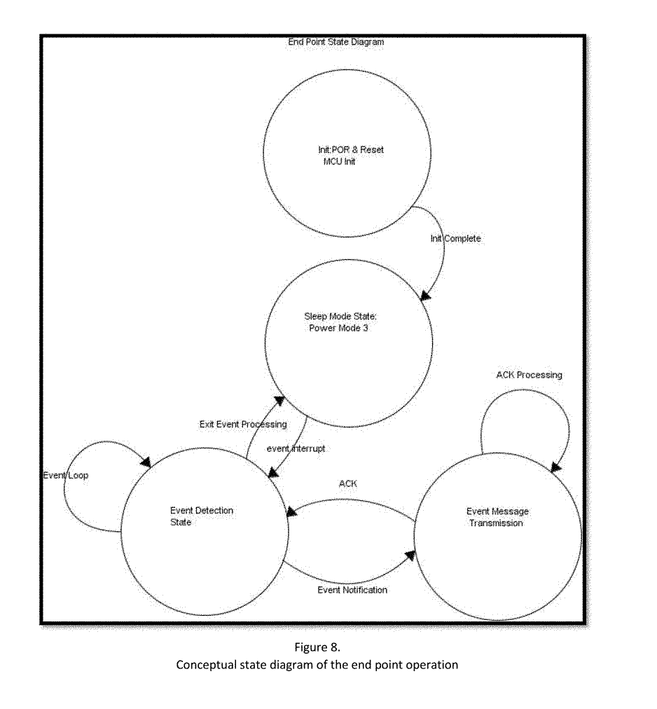

The Message routing supports patient monitor network API via Coordinator Communication. During the design and development cycle more functions may be required for the Router Node. See FIG. 7.

The two End Point Nodes in the patient monitoring network are the wetness sensing module and the call module. The main function of the end point nodes are the sensing of events and the transmission of event messages back to the patient monitoring software. The patient wireless unit End Device node will be battery-powered; to preserve batter life when the modules are not transmitting or receiving they will sleep in order to conserve power. The end point nodes will operate in the three primary modes
1. Sleep Mode
   a. TI power mode 3 (PM3), lowest power mode possible
   b. Event detection interrupts are the only things that bring the end points out of this Sleep Mode
2. Event Detection:
   a. The Wet and Call Module Event detection algorithms
      i. Wet Module
         1. Wet Event—Triggered by the wetting of a diaper ii.
      Call Module
         1. Call Event—Triggered by the pushing of the call button on the wireless patient unit
         2. Fall Event—Triggered by a fall event that trips the accelerometer
         3. Service Event—Triggered by the magnetic swipe of a caregiver verifying that service to the patient was rendered.
   b. RF electronics disabled
3. Event Message Transmission:
   a. Joining the network and sending event message to the coordinator and onto the patient monitoring software
   b. PAN and/or Network ID update

FIG. 8 is a conceptual state diagram of the end point operation.

The end points will operate in two power modes, active and power mode 3 (Sleep Mode). To conserve battery life the will spend most of its time in Power Mode 3 (PM3). Per TI CC2530 user guide: PM3: The voltage regulator to the digital core is turned off. None of the oscillators is running. The system goes to active mode on reset or an external interrupt. (Section 4.1 of the CC253x System-on-Chip Solution for 2.4-GHz IEEE 802.15.4 and ZigBee® Applications User guide) The specific external interrupts that will bring the modules out of sleep mode will be covered in the End Point Event Detection section. The module will only be active mode during the event detection and transmission states.

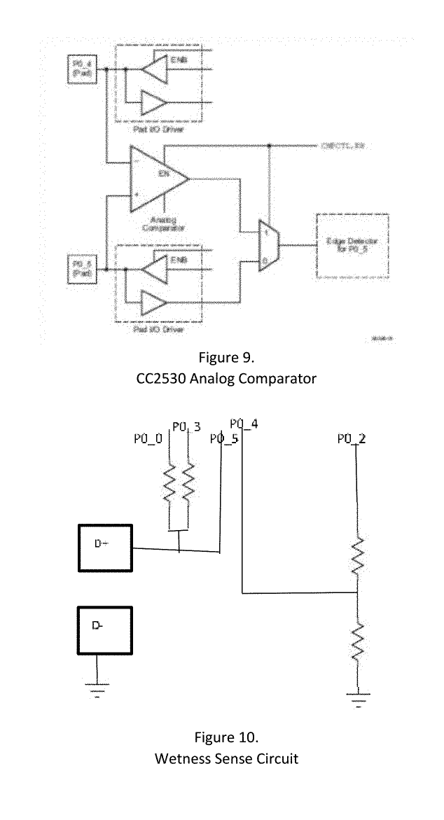

The Wet module only processes one event, the wet event. The wet event detection routine is used to determine if a patients diaper is wet. The wet event utilizes the CC2530 built in comparator, internal counters/timers and interrupt service. See FIG. 9.

The interface to the comparator is Port 0 Bit 4 (P0_4) Negative (−) Input and P0_5 Positive (+) Input. The positive input (P0_5) is connected to Diaper+(D+) and it has two pull up resisters attached to the same node which are pulled up via P0_0 and P0_3. The negative (−) Input (P0_4) is connected to a voltage divider. The figure below captures the circuit. See FIG. 10.

The initial state of the CC2530 I/O ports used in the comparator circuit is captured in the table 5.

Note: we are only utilizing one pull up resister combination on Diaper+, future algorithms may take advantages of the different resister values created by the pull up I/O port configurations. The output of the comparator is an internal signal, CMPCNTL.OUTPUT.

With a dry diaper the comparator output will be 1, during an event the comparator output will be 0. A falling edge interrupt will be enabled to capture the start of the event. The interrupt routine will do the following:
1. Put the MCU into active mode
2. Disable Comparator Interrupt
3. Set wet_counter=0
4. Verify Comparator level is tripped, i.e. low (zero)
   a. If comparator level is still low proceed to next step and start blinking LED at 5 Hz
   b. If comparator level is not low then a wet event did not occur, re-enable interrupt, exit interrupt routine and go to Sleep state
5. Start “de-bounce” timer for 1 s (TBD-001) second
6. After the 1 s (TBD-001) seconds
   a. If comparator level is still low a wet event has occurred
      i. Start blinking LED at 10 Hz
      ii. Increment wet_counter
      iii. Read internal ADC voltage (AVVD5/3, Battery Level Monitor, section 12.2.1 of user guide)
      iv. Build Event packet
      v. Start Transmit Event Watchdog timer for 10 sec
      vi. Call Transmit Event Message Function
   b. If comparator level is not low then a wet event did not occur, re-enable interrupt, exit interrupt routine and go to Sleep state
7. Wait until Transmit Event Message Function returns with an ACK or Transmit Event Watchdog timer has triggered.
8. Turn off LED
9. Set 5 min sleep timer
10. Set device into Power Mode 2
11. Wake up when sleep timer triggers
   a. If comparator level is still low diaper is still wet and alert the caregiver again with the wet counter incremented
      i. Start blinking LED at 10 Hz
      ii. Increment wet_counter
      iii. Read internal ADC voltage (AVVD5/3, Battery Level Monitor, section 12.2.1 of user guide)
      iv. Build Event packet
      v. Start Transmit Event Watchdog timer for 10 sec
      vi. Call Transmit Event Message Function
   b. If comparator level is not low then the diaper has been changed, is no longer wet enough to trigger an event, re-enable interrupt, exit interrupt routine and go to Sleep state
12. Go to step 7
   a. Routine will repeat until diaper is changed or diaper no longer wet enough to trigger event. During a diaper change the caregiver will be instructed to swipe the unit with a magnet that will trigger a processor reset putting module through initialization and into PM3

The Wet Event Message is a 32 bit message the definition of it is shown in Table 6.

The Call Module has three events it will process
1. Call Event—Triggered by the pushing of the call button on the wireless patient unit
2. Fall Event—Triggered by a fall event that trips the accelerometer
3. Service Event—Triggered by the magnetic swipe of a caregiver verifying that service to the patient was rendered.

The Call Event and Service Event are simple switch inputs that come in on standard I/O ports. Both will be set to falling edge interrupts. See Table 7.

The Fall Event routine will be covered separately.

The Call and Service interrupt routines will do the following:
1. Put the MCU into active mode
2. Disable Call/Service Interrupt
3. Start “de-bounce” timer for 30 ms
4. After the 30 ms
   a. If switch level is still low a wet event has occurred
      i. Start blinking LED at 10 Hz
      ii. Read internal ADC voltage (AVVD5/3, Battery Level Monitor, section 12.2.1 of user guide)
      iii. Build Call/Service Event packet iv. Start Transmit Event Watchdog timer for 10 sec
      v. Call Transmit Event Message Function
   b. If switch level is not low then a call or service event did not occur, re-enable interrupt, exit interrupt routine and go to Sleep state
5. Wait until Transmit Event Message Function returns with an ACK or Transmit Event Watchdog timer has triggered.
   a. If ACK pulse motor at 5 Hz for three 1 second pulses (on for a second off for a second) b. If Watchdog do nothing
6. Turn off LED
7. Re-enable interrupt, exit interrupt routine and go to Sleep state

The Call Event Message is a 32 bit message. The definition is shown in Table 8.

The Service Event Message is a 32 bit message. The definition is shown in Table 9.

The Fall event triggers when the patient call module detects the patient falling to the ground. This algorithm is very new and will require data collection and modification of the parameters in the Call Module over time. The analog devices ADXL345 is a small, thin, low power, 3-axis accelerometer with high resolution (13 bit) measurement at up to ±16 g. Digital output data is formatted as 16-bit twos complement and is accessible through either a SPI (3- or 4-wire) or I2C digital interface. The port definitions are shown in Table 10.

The interrupt routine for the fall event has not been defined yet. The following URL has a straw man implementation of how this event will be processed.

http://www.analog.com/library/analogdialogue/archives/43-07/fall_detector.html

Once a fall has been determined the same message transmission and ACK sequence followed by the Call and Service events will be used. The Fall Event Message is a 32 bit message as defined in Table 11.

End Point Transmission Event Message. Both the Wet Module and Call Module will utilize the same ZigBee end point networking function. This function is straight forward and simplified to maximize battery life for the end point nodes. The end point modules will only transmit a message if an event has occurred. Prior to the transmit event message function being called the RF portion of the CC2530 will be powered off/disabled. The transmit event message function will pass a pointer to the event message packet. The function flow will be:
1. Initialize/Enable Network hardware.
2. Join the network, connect with a Router or Coordinator
3. Transmit Message
4. Start 9 second ACK watch dog
5. Wait for Acknowledgement (ACK):
   a. Standard ACK: set ACK=1
   b. New PAN or Network ID ACK: update PAN and or Network ID set ACK=1
   c. After 9 second watch dog if ACK not received set ACK=0
6. Disable Network hardware
7. Return function with ACK

Development Hardware Platform. The coordinator, router and end point modules were designed to take advantage of bread board hardware available from TI. Initial coordinator and router development will be done on the CC2351 USB Dongle. Initial end point development will be done on the CC2530 Evaluation Module (EM).

### Patient Monitoring System

This portion of the document captures the technical description of the Patient Monitoring System.

The Patient Monitoring System consists of three major parts:
1. Patient Monitoring Local Application: Central control application locally hosted on a PC at a single facility;
   a. Facilitates management of patient and caregiver data for both new entries and updates
   b. Interfaces with Patient monitoring web application to transfer patient information to/from the database and message traffic between Zigbee Network and caregiver network
   c. Manages the patient module Zigbee Network. Note the Zigbee Network hosts two patient monitoring module end points, a patient call module and patient wet module. The details of this network and supporting hardware are captured in the Zigbee Network TRD.
   d. Interfaces with Caregiver application network (either directly or through the patient monitoring web application). Note: caregiver application is an android/IOS based app that allows a nursing home caregiver to capture and be notified of pertinent patient services required and observations made during the patient interaction.
2. Patient Monitoring Web Application: Main Control Application for all the homes that is remotely hosted;
   a. Manages message traffic between the Patient Monitoring Local Application and the Patient Monitoring Database. Note: This portion of the application may be hosted on the local machine if internet connectivity isn't reliably available.
   b. Manages message traffic between the Patient Monitoring Local Application and the caregiver application. Note: This portion of the application may be hosted on the local machine if internet connectivity isn't reliably available.
   c. Hosts data reporting websites for management, patients and patients families to allow easy and efficient data reporting display of pertinent data.
   d. Interfaces with the Patient Monitoring Database to store patient data and services provided and requests data sets from the server for the reporting websites
3. Patient Monitoring Database: Patient Database for all nursing homes that is remotely hosted
   a. Interfaces with the Patient Monitoring Web Application to store and provide patient data

Refer to FIG. 1.

The following will capture in detail the technical description of each one of the three patient monitoring subsystems.

The Patient Monitor Web Application is a remotely hosted application that serves as the main Control Application for all the assisted living homes. The Patient Monitor Web Application primary functions for each home;
1. primary interface to the data base,
2. manages message traffic between patient monitor application local to the home, the caregivers assigned to the home and the database
3. Hosts a local/regional manager website that supports new home creation and data reporting websites for managers and patient's families.

The patient monitor web application has a secure connection to the main database and each home web instance interfaces to its data base home instance. The interface has a standard set of interfaces that allow the web application to dynamically learn the database structure and allow it to read, write and create fields with in an instance. It will has the capability to create new assisted living home instances.

Both the local patient application and the caregiver application act as end points when interfacing with the web based patient application.

The message traffic from the local patient monitor application and the caregivers will consist of the following;
1. Messages from the local patient monitor application are:
   a. Patient Information messages from the local patient monitor software to be stored in the database
      i. New home creation request
         1. From: Patient monitor local program at the new home with a pre assigned login and password that will authorize the patient monitor web application to create a new database entry for the home.
         2. To: Database to create new home
         3. To: Patient monitor local program requesting a home username and login.
      ii. Patient Monitor Log In Request
         1. From: Patient monitor local program log in request.
         2. To: Database for log in authentication
         3. To: Patient monitor local program with token iii. New patient information and or changes (Name, Birthday . . . Anything in their profile)
         1. From: Patient monitor local program patient manager application
         2. To: Database iv. Patient Call Module End Point Address
         1. From: Patient monitor local program, contains the patient's call module Zigbee end point address (Patient monitor local program just received the address via the Call Module Sync request from the call module)
         2. To: Database to be stored in the patient's database profile
      v. Patient Wet Module End Point Address
         1. From: Patient monitor local program, contains the patient's wet module Zigbee end point address (Patient monitor local program just received the address via the Wet Module Sync request from the call module)
         2. To: Database to be stored in the patient's database profile
      vi. Patient Caregiver mapping, captures the patient's caregivers assigned to the patient
         1. From: Patient monitor local program patient caregiver manager application
         2. To: Database vii. Patient care plan, captures the patient's caregiver service plan, includes all the service and observation listings along with all applicable meta data (as defined in the data base section). See Screen Capture 7.
         1. From: Patient monitor local program patient caregiver manager application
         2. To: Database viii. Patient medication entry, captures a patient's medication listing, and the addition, edit or removal of a patient's medication.
         1. From: Patient monitor local program patient medication manager application
         2. To: Database to be stored in patient's medication listing ix. Patient medication administered, message that captures the date/time of the medication administration for a patient.
         1. From: Patient monitor local program patient medication manager application
         2. To: Database
      x. Patient Monitor Local Application Log Off Request
         1. From: The Local patient monitor Application with log off request
         2. To: patient monitor web application to releases token

Zigbee Patient Module Messages (Via Local Patient Monitor)
2. Alert messages from the Zigbee patient modules are stored in the database and also to the caregiver assigned to the patient
   i. Wet Event
      1. From: Patient wet module via patient monitor local application
      2. To: Patient's wet log in the database
      3. To: Wet Alert message to Caregiver's currently logged. ii. Call Event
      1. From: Patient call module via patient monitor local application
      2. To: Patient's call log in the database
      3. To: Call Alert message to Caregiver's currently logged. iii. Fall Event
      1. From: Patient call module via patient monitor local application
      2. To: Patient's fall log in the database
      3. To: Fall Alert message to Caregiver's currently logged.
   iv. Low Battery Event

1. From: Patient wet or call module via patient monitor local application

2. To: Patient's battery log in the database

3. To: Low Battery Alert message to Caregiver's currently logged.

Zigbee Patient Module Messages (Via Local Patient Monitor)

The patient monitor web application supports a web portal that allows users, of different access levels, to generate database reports via a personalized web site interface.

The personalized data reporting capabilities of the web page supports both tabular and plotting of the database entries. The data available to the user is specific to the users log in authorization settings.

For example, the login for a patient's family member will only allow the trending and display of the patient's data. A manager of a home is able to track all of the patients in the home and create reports at the home level that will allow it to better manage the home, i.e. diaper usage or number of patients with a cold.

The owner of numerous homes have the ability to see all of the homes and their patients in those homes and also create reports generated from data from all the homes, allowing the business owner the ability to trend and monitor items at the top level, i.e. number of patients per home, resource utilizations.

Each user has their own work space that is tied to their login, they have the ability to customize their page such that when the page is closed and revisited all the customizations will be displayed. The user also has the ability to generate email or text alerts based on condition statements against any data field they have access to. For example, a home manager could set up a low diaper inventor alert which will send the manager an email when the diaper inventory for their home reaches a certain point. For the patient's family it could be an alert that their loved one has had a fall or that the caregiver has reported a depression observation and that they should go and visit their loved one. This type of notification service will help ensure a better level of care is provided to the patient. The notifications will be login specific and will only be seen by that person. See Screen Capture 21 for alerts.

To create a new family monitor web account, the patient will sign a release form authorizing the release of their care to their family. Then the family member will be able to go online and create a new account linking to the home/patient they are authorized to see. For a manager or owner that authorization will be setup at the time of system set up by an authorized Smart Diaper employee.

The website portal will only use secure connection protocols to guarantee patient information is not inadvertently released.

The Patient Monitor Local Application is a locally hosted application on a computer at the assisted living home and supports the following functions
a. Facilitates management of patient and caregiver data for both new entries and updates
b. Interfaces with Patient monitoring web application to transfer patient information to/from the database and message traffic between Zigbee Network and caregiver network
c. Manages the patient module Zigbee Network. Note the Zigbee Network hosts two patient monitoring module end points, a patient call module and patient wet module. The details of this network and supporting hardware are captured in the Zigbee Network TRD
d. Interfaces with Caregiver application network (either directly or through the patient monitoring web application). Note: caregiver application is an android/IOS based app that allows a nursing home caregiver to capture and be notified of pertinent patient services required and observations made during the patient interaction. The details of this application are covered in the Caregiver TRD See Screen Captures 8 and 22.

Data Input Interface

The user input interface for the patient monitoring tool is a simple interface that will allow the operator to easily input a new patient or caregiver and/or easily update the patient or caregiver's information.

The User Input Interface shall have easy and straight forward navigation buttons to add new objects to the data base and to easily add the first order data:
1. Several Log In types
   a. Standard User
   b. Medication Nurse
   c. Manager
2. Add a new nursing home See Screen Capture 1.
   a. Enter in Information
3. Add a new Patient See Screen Capture 2.
   a. Enter in Information
   b. “Sync Patient Wireless Module” Button
      i. Window will open up walking the user through the following
      ii. “Push call button on Patient Wireless Module”
      iii. If transmission is received report the Patient Wireless module Node ID number and report that it has been linked to the patient.
      iv. If no transmission is received within 30 sec report that no transmission has been received and that if you had attempted to send a message that the battery in the module may need to be replaced. “OK” button to close the window.
   c. Sync a Zigbee Patient Wetness Module
      i. Window will open up walking the user through the following
      ii. “Short with a paper clip the two connection nodes on the Patient Wetness Module” iii. If transmission is received report the Patient Wetness Module Node ID number and report that it has been linked to the patient.
      iv. If no transmission is received within 30 sec report that no transmission has been received and that if you had attempted to send a message that the battery in the module may need to be replaced. “OK” button to close the window.
4. Add a new Caregiver
   a. Enter in Information

The patient monitoring software interfaces with a Zigbee driver that communicates with a USB connected Zigbee receiver/transmitter

The interface driver is a simple application that interfaces to the TI CC2531 micro controller. The TI CC2531 will act as the Zigbee network coordinator node. The Zigbee network is a quasi-Mesh and Tree Network (The Wet and Call Modules are only end point nodes that don't communicate with each other). See FIG. 2. The coordinator node will always be connected to the PC running the local patient monitor software.

The interface driver will message the patient monitoring software when it has received an event from the zigbee network.

The interface driver will pass the following information to the patient monitoring software.

| | |
|---|---|
| Zigbee ID | Double Word (32 bit) |
| Packet Sequence | Word (16 bit) |
| Event: | Word |
| Fall Event | Bit 0 (lsb) |
| Call Event | Bit 1 |
| Service Provided Event | Bit 2 |
| Wet Event | Bit 3 |
| Battery Low | Bit 4 |
| Spare | Bit 5: 15 (msb) |
| Retransmits | Byte |

Zigbee ID: The node ID of the patient wireless unit that sent the event message. This ID is synced to a specific/unique patient and the information in the message and is added to the patient's data base via this ID.

Packet Sequence: The patient wireless nodes puts a sequence count on each unique message it sends. If the patient monitoring software receives multiple copies of a message from the same node (transmitted via different network paths) it will ignore all duplicate messages and only update the data base once.

Event: The event is the information sent from the wireless node indicating what event was it that generated this message. The local patient monitoring software will message the web based patient monitoring update the patient's data base with this event data along with a time tag.

Retransmits: The retransmit count is the number of times the patient wireless node sent a message before it received acknowledgement from the patient monitor Zigbee driver. If the count is greater than 1 or 2 it may indicate a weak network connection to a node and the caregiver is notified to visit the patient and adjust the patient wireless module for better transmission.

In addition to the event data being stored into the data base the patient monitor will also alert the caregiver, by sending it a WiFi message. This message will alert the caregiver that a patient requires care

Caregiver Interface

The local patient monitoring application does not communicate directly with the caregiver WiFi network but instead interfaces with the web based patient monitoring application. The web based patient monitoring application messages with the caregiver's application. The web based patient monitoring application then messages the local application the pertinent caregiver messages and vice versa for messages originating from the local patient monitoring application.

Messages are captured in the web based patient monitoring application section.

The caregiver application runs on a touch screen tablet or other electronic device.

The local patient monitoring application interface function:
1. Send messages to the caregiver application via the web based patient monitoring application
   a. Call, Wet, Low Battery and Fall events from the Zigbee network are broadcast to all currently logged in caregivers
2. Receive messages from the caregiver application via the web based patient monitoring application
   a. Service events

The messages received from the care giver app feed directly into the patient services and observation object database. The messages inform the patient monitoring software which services and/or observations were done and to what patient. The patient is listed by name and the patient data received from the caregiver will be entered into the patient's database via this name along with a time stamp. See Screen Captures 19 and 20.

Since both the patient monitoring software and the caregiver application will be running on machines with Operating systems the messaging format will be a straight forward XML message that the patient monitoring software and caregiver software can parse and store.

The Caregiver Receiver XML message needs to include
1. Caregiver Name
2. Patient Name
3. Services provided
4. Observations

The patient monitoring software will also has the capability to send messages to the care giver app

The message types the patient monitoring software send are
1. Event Notification XML message
   a. Patient Name
   b. Event Information
2. Patient wireless module receive strength
   a. Patient Name
   b. Information on how many transmits it is taking for the patient to get acknowledgement
3. Current Patient List XML message
   a. List of current patient names that the caregiver can select from

Local Application Pages

The following pages/tabs allow the user to:
1. Patient Information
2. Patient Services/Observation Profile Page
3. Caregiver Page
4. Medication Page See Screen Capture 10.
5. Message Log Page
6. Patient Log Page See Screen Capture 9.

Patient Information Page

This allows the user to view, add and edit patient information. It has input fields for the standard patient information (database “patient information” table captures the fields). There is an “Add New Patient” and Edit New Patient” action buttons. These buttons will facilitate the entering of this information. See Screen Capture 2 thru 5.

A key function of this page is to sync the patient's Wet and Call modules to its profile. There are two action buttons that facilitate this;
Sync the Call Module:
   1. Sync of the Zigbee Call Module involves the user being prompted to push the “Call” button on the call module. This will send a message to the Zigbee network which will always be setup accept new end points within the house's network ID. The user will be prompted to select OK when the most recent ID received should be mapped to the patient currently selected. If for some reason a Call module is already mapped to an existing patient the Sync function notifies the user of this and requires a new module or to delete the current patient's ID from the database.
   2. Sync of the Call Module Optical QR Code involves the user being prompted to scan with a caregiver app of the Optical QR image on the Call Module. The caregiver app needs to be in the new patient sync mode. This will result in the caregiver sending a new QR message to the web based patient monitor system and it will immediately pass that to the local application for verification. The user clicks OK to complete the transaction. Similar to the Zigbee Call Module sync the web based patient monitor will also verify the QR does not already exist in the homes database.
   3. the Wet Module:
      1. Sync of the Wet Module involves the user being prompted to trigger a Wet event on the Wet Module. This will involve the diaper connections shorted together for five seconds. This will send a message to the Zigbee network which will always be in setup mode for this action, to accept new end points within the house's network ID. The user will be prompted to select OK when the most recent ID received should be mapped to the patient currently selected. If for some reason a Wet module is already mapped to an existing patient the Sync function notifies the user of this and requires a new module or to delete the current patient's ID from the database.

Patient Services/Observation Profile Page

This page allows the nursing home to setup and customize each Patient's Services and Observation Profile Page.

Via a pull down patient name display any of the patients currently enrolled in the home can be selected.

The left side of the page are images and captions of all the currently available services and observations. These images will be provided to the local application via message requests from the web based application.

The right side of the page has a rendering of the caregiver application screen with the current service and observation tasks for that patient. For new patients a default layout of the default services and observations is displayed. See Screen Capture

The user has the ability to drag the icons onto any of the services or observation locations removing the service/observation currently occupying that spot. The mapping constrains services to services and observations to observations. See FIG. 2.

Once each icon has been placed each icon can be selected giving the user the ability to define a schedule for each service/observation task. The user is able to select days of the week and appropriate time intervals. It also allows the user to enable a notification to the assigned caregiver to notify them when a service/observation is pending, prompting the caregiver to visit the patient. For any patient visits, the services and observations required for this visit are highlighted to remind the caregiver. The default for this schedule function is every day and every visit but with notification disabled for all tasks.

When the user is done updating the patients care profile it is saved and the profile messaged to the web based application and stored in the data base to be retrieved and displayed by the caregiver during visits. The Web based patient monitor will monitor the patient profile notifications and message the caregiver. See Screen Capture 11.

Caregiver Information Page

This allows the user to view, add and edit caregiver information. It has input fields for the standard caregiver information (database “caregiver information” table captures the fields). There is an “Add New Caregiver” and Edit New Caregiver” action buttons. These buttons facilitate the entering of this information. A key function of this page is to setup a caregiver username and password to allow the caregiver to login to the caregiver application in order access the web based patient monitoring application. See Screen Captures 12 and 13 and 25.

As part of the data entry the user selects a user name. Once the caregiver information has been received by the web based application the user will be prompted to have the caregiver log into a caregiver app using a provided default password (that is only valid for 10 min). Once logged in the caregiver is prompted to create a custom secure password. From this point on the caregiver is linked to the home he/she is working for. If the caregiver works for several homes a separated username will be setup for each home.

Medication Page

The medication page is a simple table page that reports all of the patients current medications. It displays in event order which patient needs which medications when. The action buttons allow an authorized user to Add, Delete and Modify medication entries. When medication is serviced the authorized user is able to click on the pending task removing it from the table. This sends a message to the web based application resulting in a database update for the patient the medication was provided to. See Screen Capture 6 and 15 and 16.

Message Log Page

The message log page will just list all the messages that have that been received by the patients and caregivers. The format of this log page is shown below.

| Patient or | | | | Event/ |
|---|---|---|---|---|
| Caregiver | | Caregiver | | Service/ |
| Message | Patient Name | Name | Date/Time | Observation |
| Patient | John Doe | Jolly Service | 11/23/13 16:35 | Wet |
| Caregiver | John Doe | Jolly Service | 11/23/13 16:40 | Diaper |
| | | | | Changed |
| Caregiver | Susan Singing | Great Care | 11/23/13 17:47 | Changed |
| | | | | Linens |
| Caregiver | Susan Singing | Great Care | 11/23/13 17:47 | Bathed |

The log message page has the capability to filter on each column and select time ranges

The user input page is not capable of changing the time/date stamp Activities and Observation logs

Patient Log Page

The patient history page is similar to the message log page but it includes the patient's personal information only. The top of this page has the patient's user input information (Name, picture, M/F, . . . ) and then below are three different tables one displaying all the Events, the second displaying the services and the third displaying the observations. See Screen Captures 17 and 18.

The tables have the same control as the table in the message log page.

Patient Monitor Database

The Database is a secure structured type data base (SQL). It can be viewed as an object oriented type structure with the Parent Class being of type Assisted Living Home. The Class Assisted Living Home will have two objects/child instances, patient and caregiver, these lower level classes capture the pertinent data for each instance along with a growing set of service data that the care giver provides to the patient and patient events.

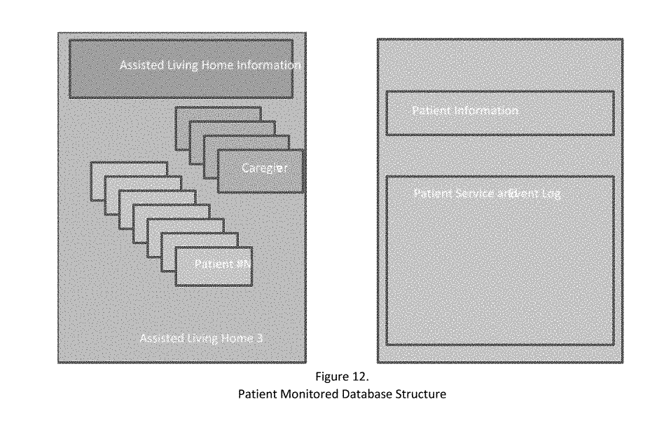

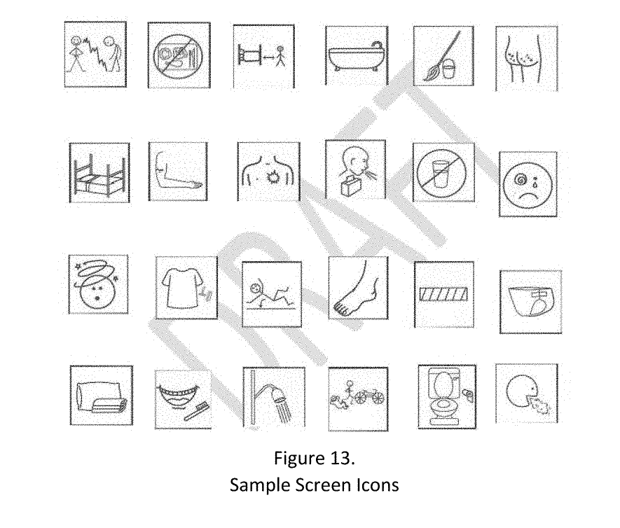

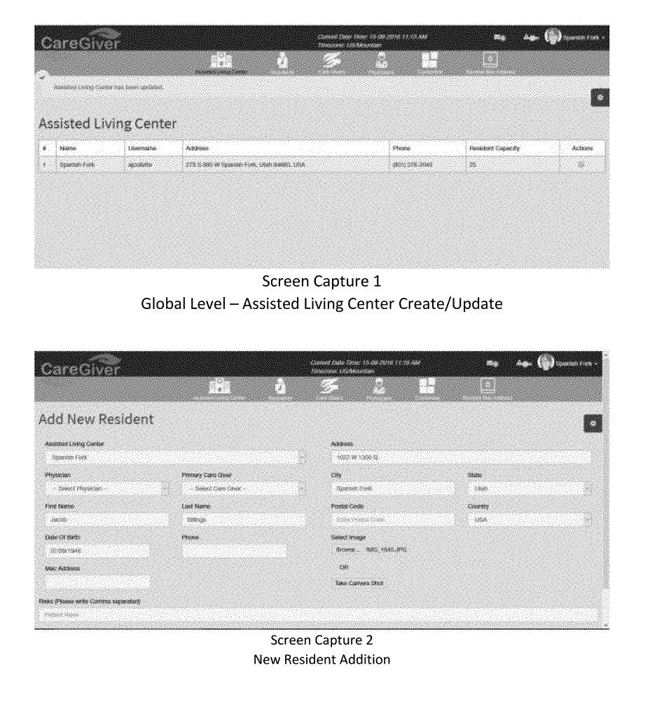

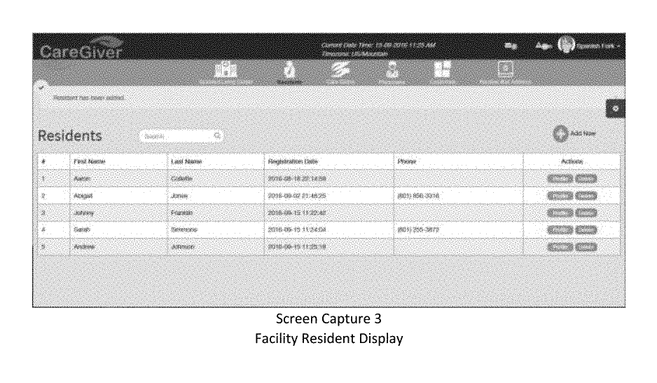

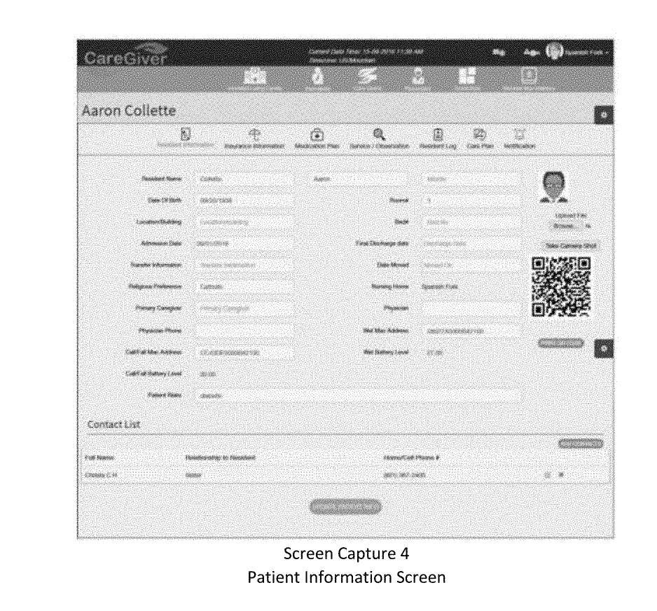

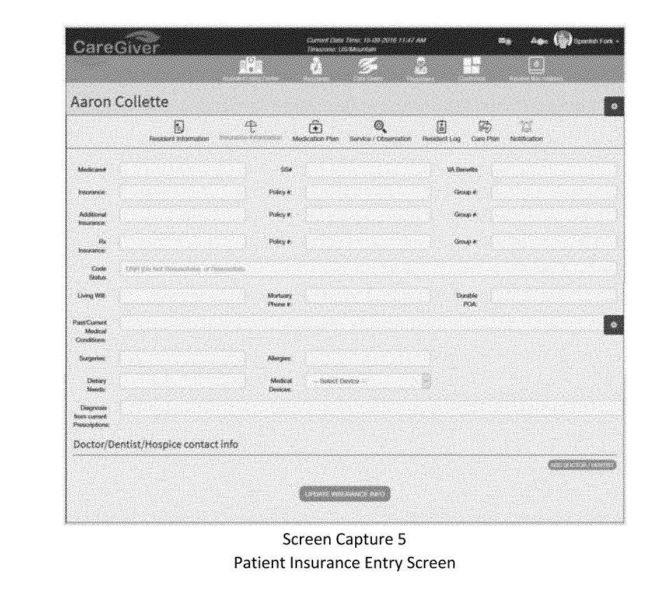

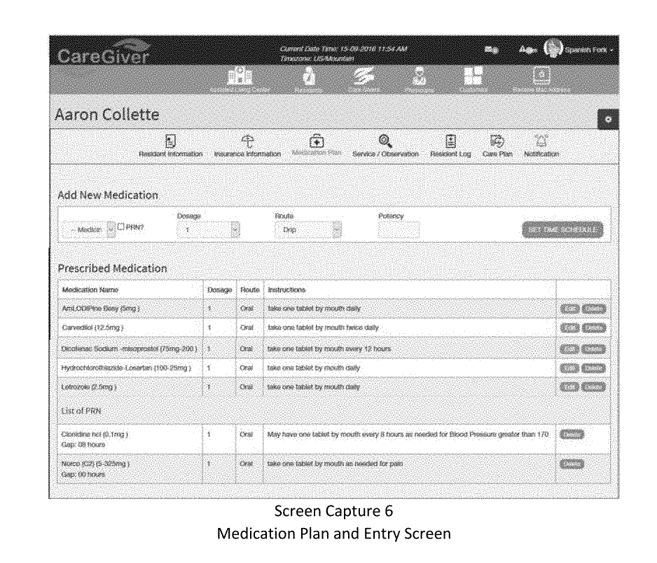

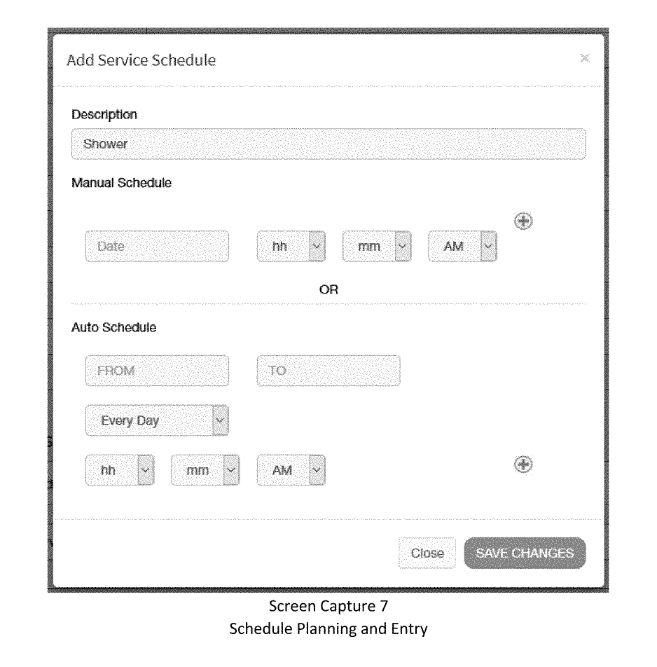

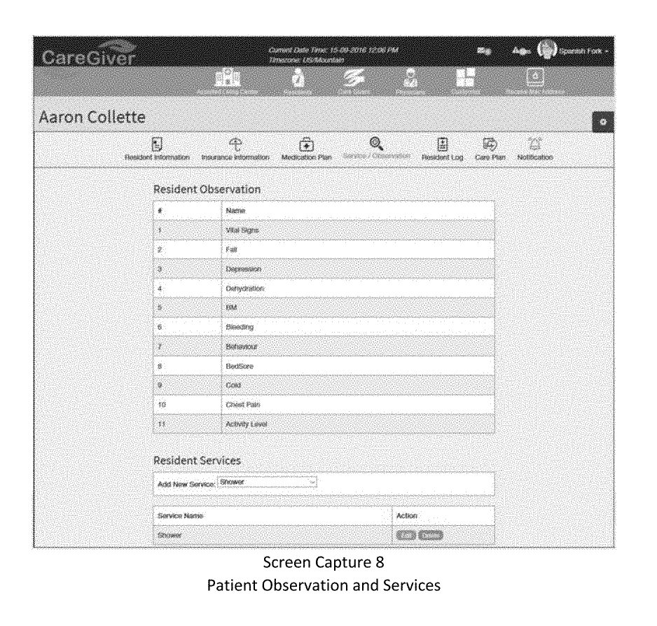

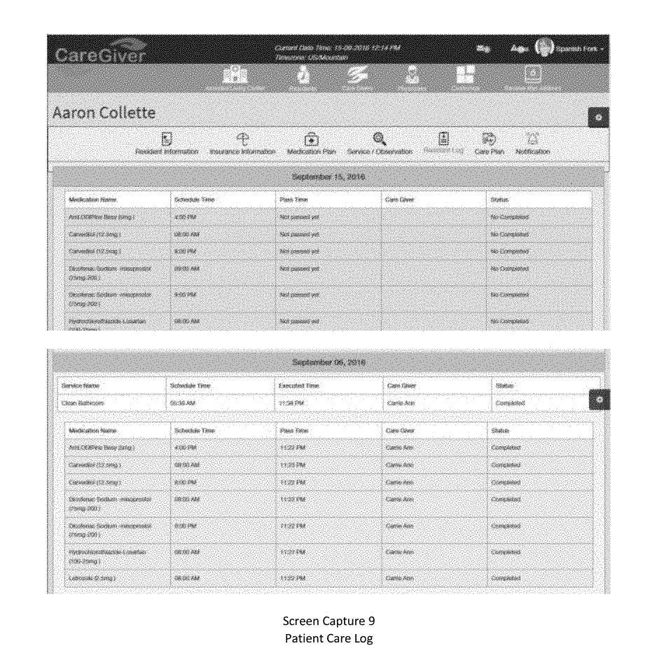

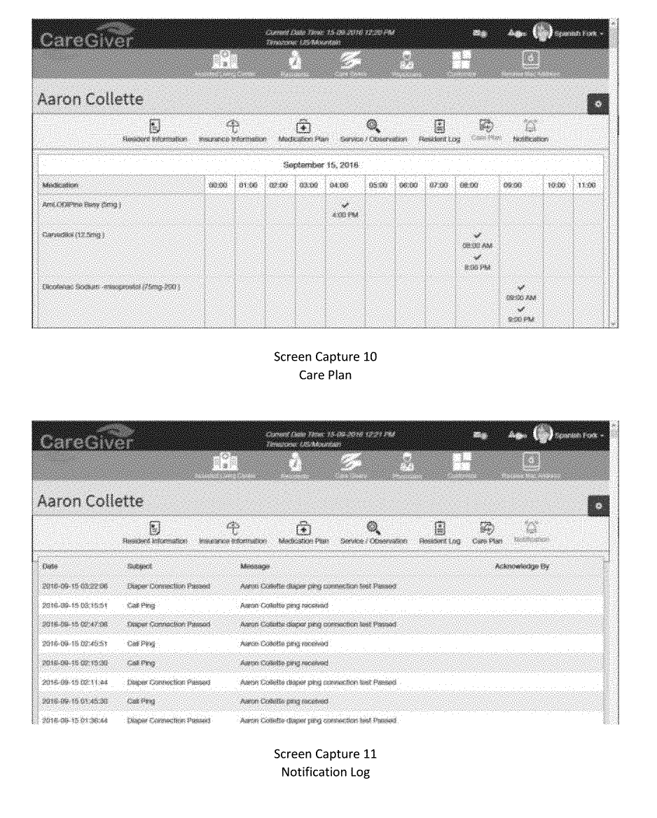

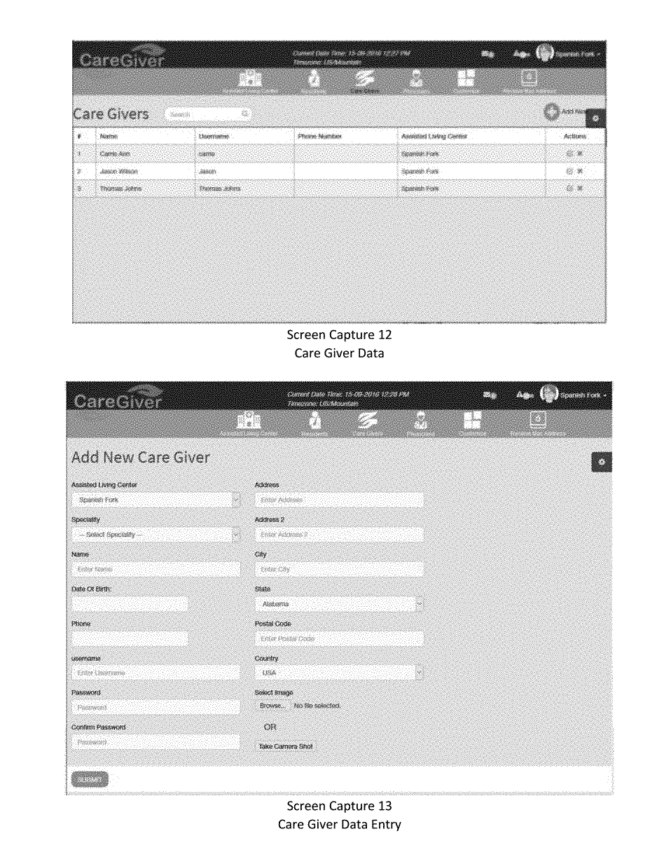

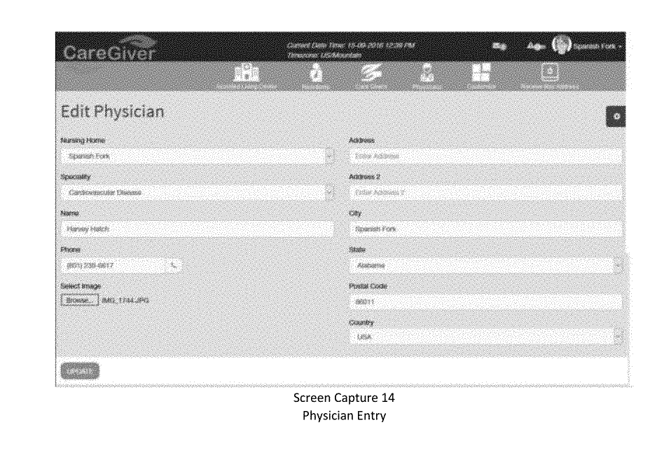

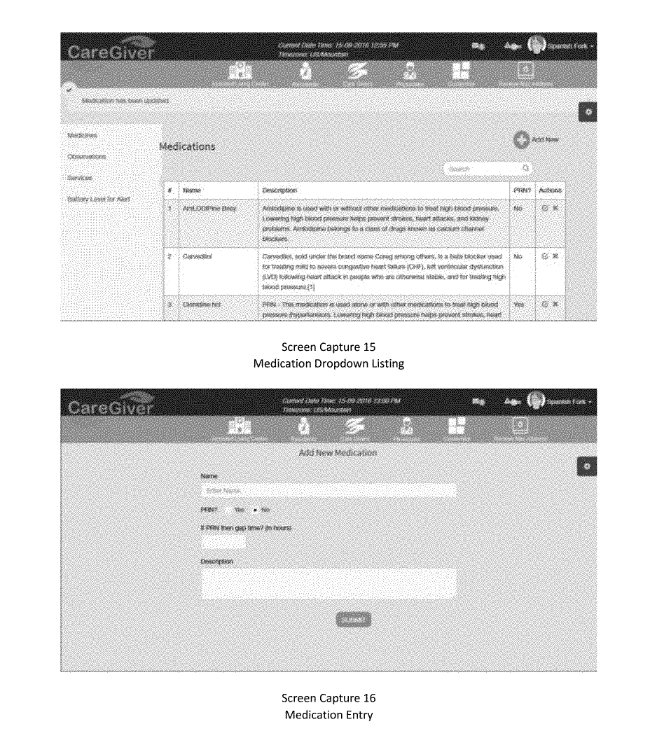

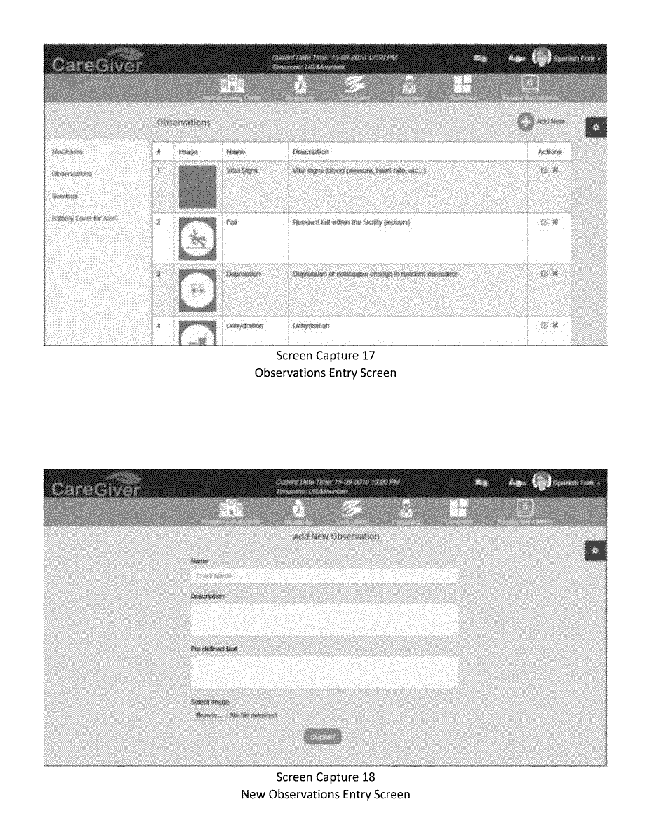

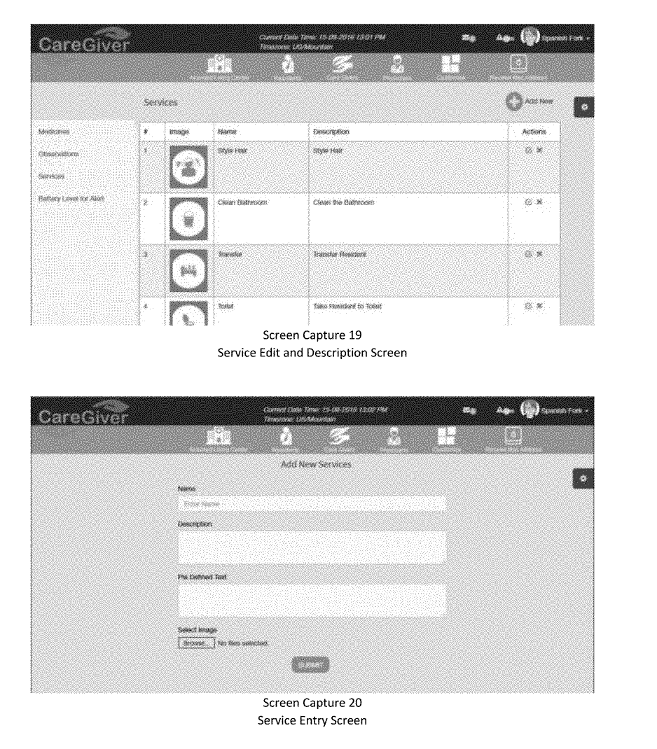

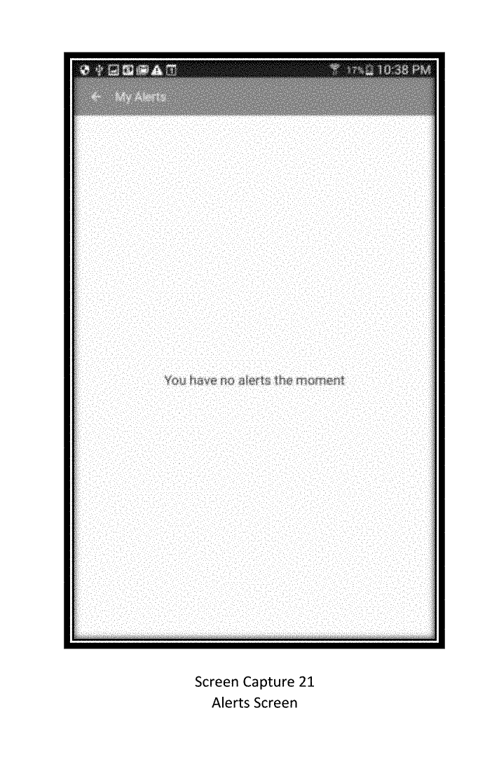

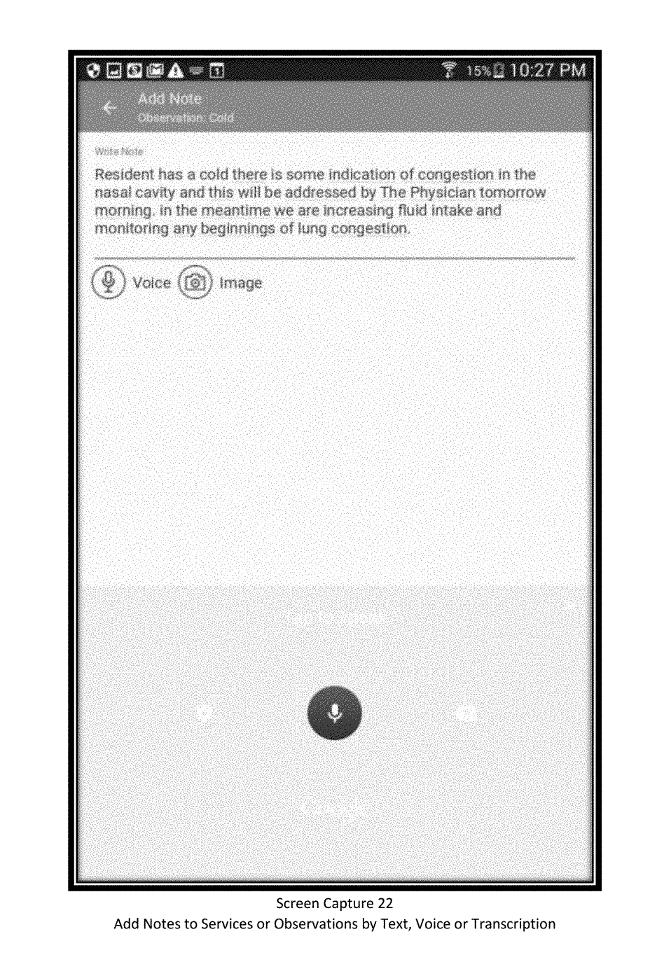

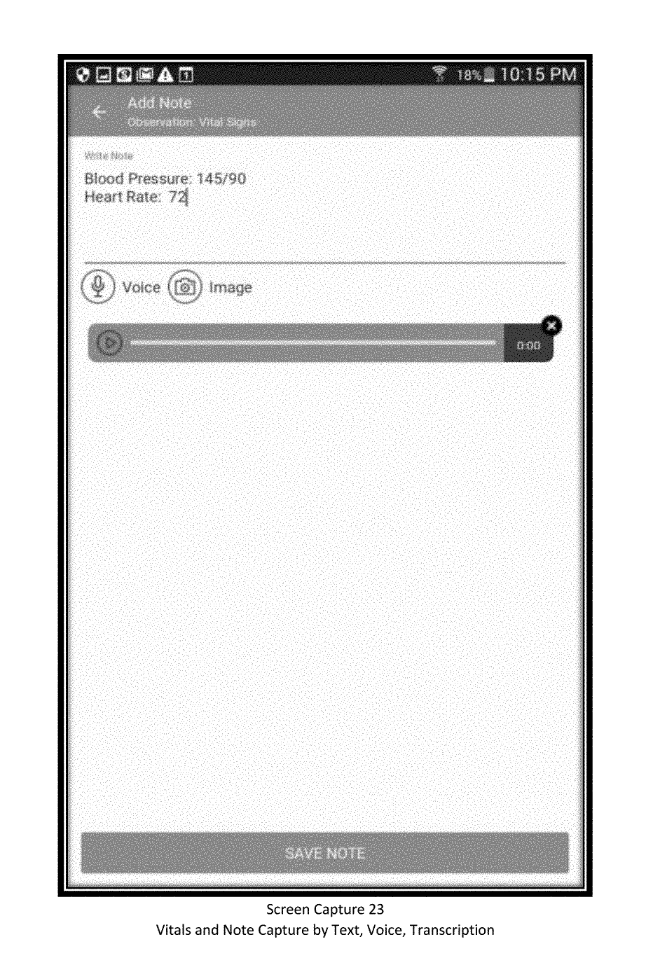

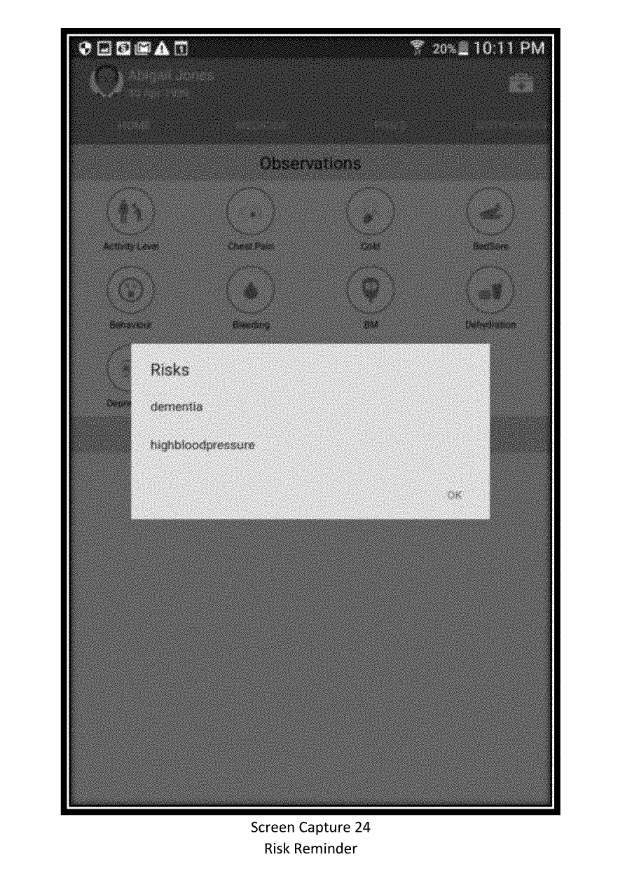

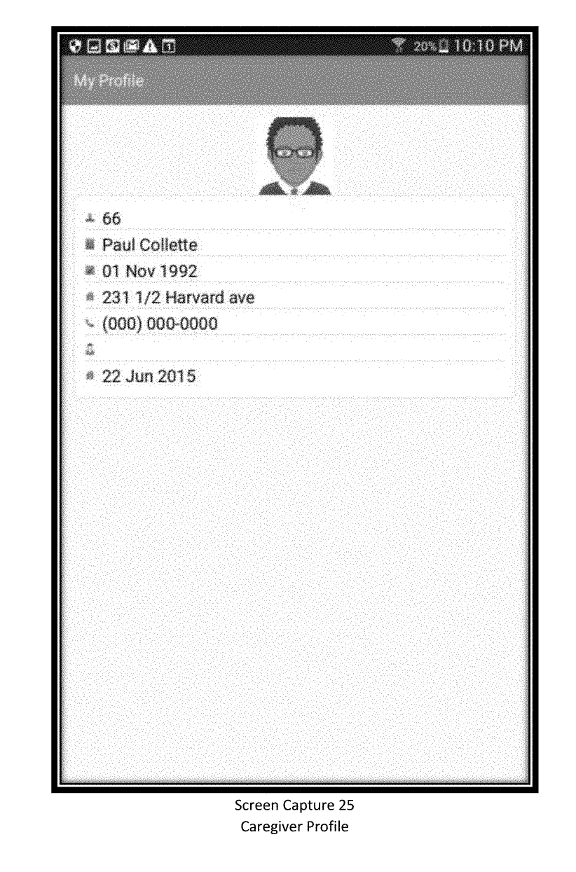

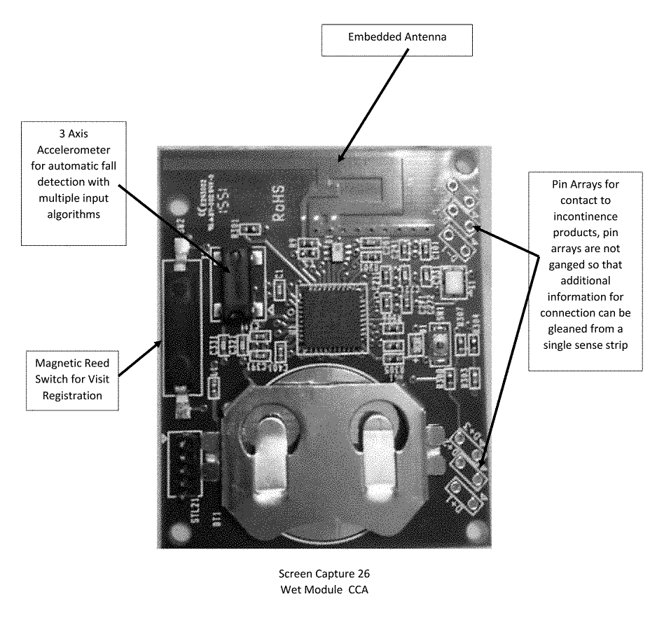

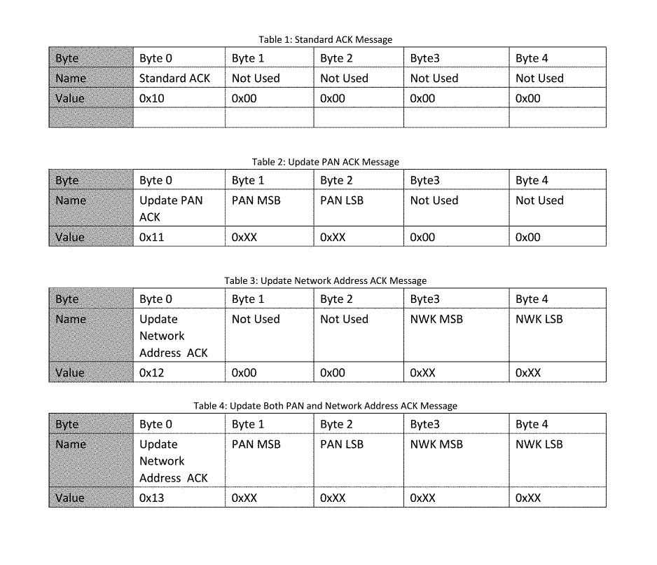

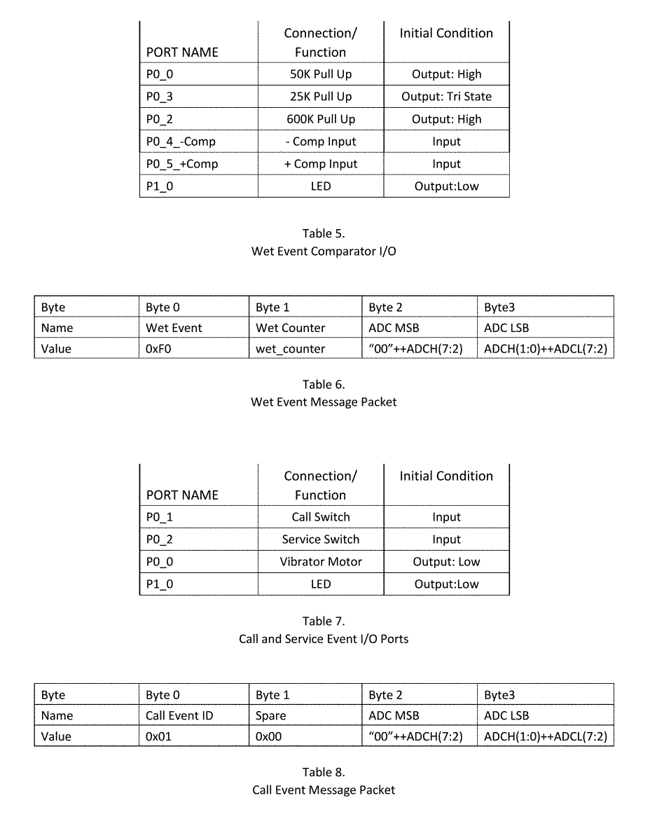

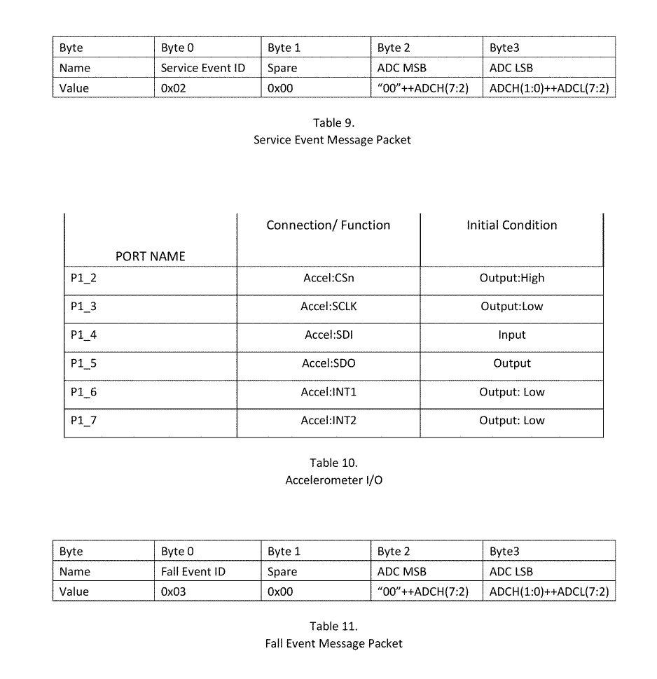

The top level of the database consists of numerous instances of assisted living homes. Assisted living homes can be grouped into sets, for example Beehive homes may have 10 homes, each home will have an Assisted living home instance that keeps track of the home information and all of the caregiver and patients within that home. The owner of Beehive will have the ability to query data from all homes or across all homes but will not have the ability to query another companies home. The data base is secure and will not allow unauthorized users. See FIG. 12.

Assisted Living Home Information

General information about the home that can be accessed by users

| Field | Data Type |
|---|---|
| Name | String |
| Address | String |
| Phone Number | String |
| Patient Capacity | Int |
| . . . | |

Caregiver Information

Each home will have a set of caregivers that care for the patients. This database entry will allow the caregiver to log into the caregiver application and access the patient monitor software applications

| Field | Data Type |
|---|---|
| Name | String |
| Username | String |
| ID Number | Int |
| Phone Number | String |
| Picture | Image_ID |
| Start Date | String |

Patient Information (Patient Class)

Captures the basic information about a patient to be entered into the database via the patient monitor local application when a new patient is being added or if updates to an existing patient.

| Field | Data Type |
|---|---|
| Name | String |
| Username | String |
| Patient_ID | Int |
| Phone Number | String |
| Picture | Jpeg |
| Admitted Date | String |
| Allergies | Array String |
| Patient Wireless Module ID | Double |
| Patient Wireless Wetness Module ID | Double |
| . . . | |

Medication

The medication will capture a list of all the medications a home is utilizing, each patient will have a medication list to manage their medication

| Field | Data Type |
|---|---|
| Medication_ID1 | Drug Name |
| Medication_ID2 | Drug Name |
| . . . | |
| Medication_IDN | Drug Name |

Patient Services

Patient Services will be accessible to all homes. The patient local application will make them available to the caregivers during the patient care setup process. New Services will be added by the software administrator via the web portal of the patient monitor web application

| Field | Data Type |
|---|---|
| Service_ID1 | List{Service_Name, Description, Image_ID} |
| Service_ID2 | List{Service_Name, Description, Image_ID} |
| . . . | |
| Service_IDN | List{Service_Name, Description, Image_ID} |

Default List of Services;
1. bed_made,
2. linens_changed,
3. bathroom_cleaned,
4. bathed,
5. showered,
6. oral_care,
7. foot_care,
8. incontinent_care,
9. therapy,
10. assisted_transfer,
11. dress_hygiene,
12. toileting,
13. bed_reposition

Patient Observations

Patient Observations will be accessible to all homes. The patient local application will make them available to the caregivers during the patient care setup process. New Observations will be added by the software administrator via the web portal of the patient monitor web application

| Field | Data Type |
|---|---|
| Observation_ID1 | List{Observation_Name, Description, Image_ID} |
| Observation_ID2 | List{Observation_Name, Description, Image_ID} |
| . . . | |
| Observation_IDN | List{Observation_Name, Description, Image_ID} |

Default List of Observations:
1. fall,
2. bed_sores,
3. hazard,
4. activity_level,
5. loss_of_appetite,
6. depression_confused,
7. dizziness,
8. nausea_vomiting,
9. cold_symptoms,
10. dehydration,
11. chest_pain, bleeding

Image Item

Images will include service and observation caregiver display images. It will also support Image_blobs of all types to facilitate the storage of caregiver's pictures of patient observations or services provided, i.e. bed sores.

| Field | Data Type |
|---|---|
| Image_ID1 | Image_blob |
| Image_ID2 | Image_blob |
| . . . | |
| Image_IDN | Image_blob |

Note Item

Notes are small text entries entered by the caregiver to allow more specific information on an observation or service provided. The Note_blobs will be linked to each caregiver patient service or observation event. See Screen Captures 23 and 24.

| Field | Data Type |
|---|---|
| Note_ID1 | Note_blob |
| Note_ID2 | Note_blob |
| . . . | |
| Note_IDN | Note_blob |

Document Item

Documents common to an assisted living home with instances tied to the individual patients.

| Field | Data Type |
|---|---|
| Doc_ID1 | document_blob |
| Doc_ID2 | document_blob |
| . . . | |
| Doc_IDN | document_blob |

Billing Item

Simple billing structure that allows each patient a custom billing id, this information will be tied to the patient and viewable via the local application or web portal

| Field | Data Type |
|---|---|
| Billing_ID1 | Billing_name, amount |
| Billing_ID2 | Billing_name, amount |
| . . . | |
| Billing_IDN | Billing_name, amount |

Schedule Item

| Field | Data Type |
|---|---|
| Schedule_ID1 | List{Sunday, Monday, Tuesday, Wednesday, Thursday, |
| | Friday, Saturday, days_of_month (eg. 1, 8, 9, 12, 27), |
| | time_of_day} |
| Schedule_ID2 | List{Sunday, Monday, Tuesday, Wednesday, Thursday, |
| | Friday, Saturday, days_of_month (eg. 1, 8, 9, 12, 27), |
| | time_of_day} |
| . . . | |
| Schedule_IDN | List{Sunday, Monday, Tuesday, Wednesday, Thursday, |
| | Friday, Saturday, days_of_month (eg. 1, 8, 9, 12, 27), |
| | time_of_day} |

The following tables capture a patients specific information.

Patient's Patient_Medication (Patient Class)

| Field | Data Type |
|---|---|
| Medication 1 | List {Patient_ID, Medication_ID, Service_ID, dosage, |
| | interval, restrictions, notes} |
| Medication 2 | List {Patient_ID, Medication_ID, Service_ID, dosage, |
| | interval, restrictions, notes |
| . . . | |
| Medication N | List {Patient_ID, Medication_ID, Service_ID, dosage, |
| | interval, restrictions, notes |

Patient's Patient Services (Patient Class)

| Field | Data Type |
|---|---|
| Service 1 | List {Patient_ID, Service_ID, Schedule_ID, Note_ID, |
| | Image_ID} |
| Service 2 | List {Patient_ID, Service_ID, Schedule_ID, Note_ID, |
| | Image_ID} |
| Service 3 | List {Patient_ID, Service_ID, Schedule_ID, Note_ID, |
| | Image_ID} |
| . . . | |
| Service 16 | List {Patient_ID, Service_ID, Schedule_ID, Note_ID, |
| | Image_ID} |

Patient's Patients Observations (Patient Class)

| Field | Data Type |
|---|---|
| Observation 1 | List {Patient_ID, Observation_ID} |
| Observation 2 | List {Patient_ID, Observation_ID} |
| Observation 3 | List {Patient_ID, Observation_ID} |
| . . . | |
| Observation 16 | List {Patient_ID, Observation_ID} |

Patient's Document Listing

| Field | Data Type |
|---|---|
| Document 1 | List {Patient_ID, Document_ID} |
| Document 2 | List {Patient_ID, Document_ID} |
| . . . | |
| Document 3 | List {Patient_ID, Document_ID} |

Patient's Billing Listing

| Field | Data Type |
|---|---|
| Billing 1 | List {Patient_ID, Billing_ID} |
| Billing 2 | List {Patient_ID, Billing_ID} |
| . . . | |
| Billing 3 | List {Patient_ID, Billing_ID} |

Patient Services Record (Patient Class)

| Field | Data Type |
|---|---|
| Bed Made | List/Array of Time and Date, |
| | Caregive_ID, Note_ID, Image_ID |
| Linens Changed | List/Array of Time and Date, |
| | Caregive_ID, Note_ID, Image_ID |
| Room Cleaned | List/Array of Time and Date, |
| | Caregive_ID, Note_ID, Image_ID |
| Bathed | List/Array of Time and Date, |
| | Caregive_ID, Note_ID, Image_ID |
| Showered | List/Array of Time and Date, |
| | Caregive_ID, Note_ID, Image_ID |
| Brushed Teeth | List/Array of Time and Date, |
| | Caregive_ID, Note_ID, Image_ID |
| Foot Care | List/Array of Time and Date, |
| | Caregive_ID, Note_ID, Image_ID |
| Incontinent Care | List/Array of Time and Date, |
| | Caregive_ID, Note_ID, Image_ID |
| Physical Therapy | List/Array of Time and Date, |
| | Caregive_ID, Note_ID, Image_ID |
| Assisted Transfer | List/Array of Time and Date, |
| | Caregive_ID, Note_ID, Image_ID |
| Dress/Hygiene | List/Array of Time and Date, |
| | Caregive_ID, Note_ID, Image_ID |
| Toileting | List/Array of Time and Date, |
| | Caregive_ID, Note_ID, Image_ID |
| Turned in Bed | List/Array of Time and Date, |
| | Caregive_ID, Note_ID, Image_ID |
| . . . | |

Patient Observations Record (Patient Class)

| Field | Data Type |
|---|---|
| Fall | List/Array of Time and Date, |
| | Caregive_ID, Note_ID, Image_ID |
| Bed Sores | List/Array of Time and Date, |
| | Caregive_ID, Note_ID, Image_ID |
| Hazard | List/Array of Time and Date, |
| | Caregive_ID, Note_ID, Image_ID |
| Activity Level | List/Array of Time and Date, |
| | Caregive_ID, Note_ID, Image_ID |
| Loss of Appetite | List/Array of Time and Date, |
| | Caregive_ID, Note_ID, Image_ID |
| Depression/Confusion | List/Array of Time and Date, |
| | Caregive_ID, Note_ID, Image_ID |
| Dizzy | List/Array of Time and Date, |
| | Caregive_ID, Note_ID, Image_ID |
| Nausea/Vomiting | List/Array of Time and Date, |
| | Caregive_ID, Note_ID, Image_ID |
| Cold Symptoms | List/Array of Time and Date, |
| | Caregive_ID, Note_ID, Image_ID |
| Dehydration | List/Array of Time and Date, |
| | Caregive_ID, Note_ID, Image_ID |
| Chest Pain | List/Array of Time and Date, |
| | Caregive_ID, Note_ID, Image_ID |
| Bleeding | List/Array of Time and Date, |
| | Caregive_ID, Note_ID, Image_ID |
| Toileting | List/Array of Time and Date, |
| | Caregive_ID, Note_ID, Image_ID |
| . . . | |

What is claimed:

1. A patient monitoring system mobile software application comprising: a WiFi network and Zigbee or Thread or Low Power Blue Tooth network of coordinators/leaders, routers, and end point devices; and
an integrated call module, with an integrated call, and with automatic fall detection, and magnetic swipe or proximity sensor based visit entry; and a wet module which includes multiple staggered, non-ganged pin arrays, for attachment to sensored incontinence products and which processes and transmits an incontinent event.

2. A patient monitoring system mobile software application as defined in claim 1, wherein the WiFi network and Zigbee or Thread or Low Power Blue Tooth network of coordinators/leaders, router, and end point devices are integrated in a manner such than a nearly unlimited number of individuals can be accommodated

3. A patient monitoring system mobile software application as defined in claim 1, further comprising a software which processes incoming requests and then delegates one or more workloads automatically on an individual basis over multiple caregivers via the application.

4. A patient monitoring system mobile software application as defined in claim 3, wherein the method of care optimizes point of service care by utilizing icon taps to make entries for service or observations directly into the patient record.

5. A patient monitoring system mobile software application as defined in claim 3, integrating all caregiver software, hardware, firmware, call, visits, wet events, and falls into a single paperless application for electronic mobile devices and cloud based storage.

6. A patient monitoring system mobile software application as defined in claim 1, wherein the call module automatically detects a fall.

7. A patient monitoring system mobile software application as defined in claim 1, wherein the wet module can automatically detect a incontinent event.

8. A patient monitoring system mobile software application as defined in claim 1, wherein a visit is registered by a swipe of the call module with a magnet or by a proximity sensor.

9. A patient monitoring system mobile software application as defined in claim 3, wherein the tap of a photo icon, provides photo documentation as required, appended directly to the individual file.

10. A patient monitoring system mobile software application as defined in claim 3, wherein the software application generates and displays all tasks, notifications, alerts, calls and events in a queue until recognized by a key tap and responsibility accepted by a caregiver, at which time, the accepted item is removed from the queue.

11. A patient monitoring system mobile software application as defined in claim 3, wherein an embedded camera in the mobile device utilizes a Quick Response (QR) to access and store an individual's data at the point of service.

12. A patient monitoring system mobile software application as defined in claim 2, wherein the absence of an individual from a facility is determined by an ultralow power loss of signal system rather than a higher power, less sustainable, GPS based system.

13. A patient monitoring system mobile software application as defined in claim 3, wherein the software application allows the direct dictation, both audible, textual and photo-graphical, into a patient record with the tap of an icon.

14. A patient monitoring system mobile software application as defined in claim 3, wherein the software application allows customization of all icon based entries by each caregiving facility

15. A patient monitoring system mobile software application as defined in claim 3, wherein the software application allows addendums to any entry by the individual caregiver.

16. A patient monitoring system mobile software application as defined in claim 3, wherein the software application allows medication delivery at point of service, utilizing taps on the mobile device.

17. A patient monitoring system mobile software application as defined in claim 3, wherein the software application automatically records time, date and caregiver for each interaction with a patient.

18. A patient monitoring system mobile application as described in claim 2, wherein the application realizes a fully integrated patient monitoring system based on an Internet of Things (IOT) system.

19. A patient monitoring system mobile software application as defined in claim 2, wherein the low power ZigBee/Thread/Bluetooth network is autonomously monitored by the cloud based website and notifies the caregiver if one of the network elements is no longer online.

20. A patient monitoring system mobile software application as defined in claim 1, wherein the battery powered resident monitors send multiple copies of every message to ensure reliable message transmission to the cloud based website software. Wherein the cloud based website software filters incoming identical messages based on configurable interval ensuring only one notification is generated.
